(19) United States
(12) Patent Application Publication
(10) Pub. No.: US 2018/0053040 A1
(43) Pub. Date: Feb. 22, 2018

(54) SYSTEM AND METHOD FOR 3D LOCAL SURFACE MATCHING

(71) Applicant: UMM AL-QURA UNIVERSITY, Makkah (SA)

(72) Inventor: Faisal R. AL-OSAIMI, Makkah (SA)

(73) Assignee: UMM AL-QURA UNIVERSITY, Makkah (SA)

(21) Appl. No.: 15/242,000

(22) Filed: Aug. 19, 2016

(51) Int. Cl. G06K 9/00; G06K 9/46; G06K 9/62

(52) U.S. Cl. CPC G06K 9/00214; G06K 9/6206; G06K 9/468

(57) ABSTRACT

A system and associated methodology for three-dimensional (3D) local surface matching that extracts a treble of 3D profiles from data corresponding to a 3D local surface wherein the treble of the 3D profiles includes a central profile and two adjacent profiles, calculates a scalar sequence pair based on the treble of the 3D profiles, calculates adjustable integral kernels based on the scalar sequence pair, and provides the adjustable integral kernels to pattern recognition applications.

### BACKGROUND

The domain of 3D computer vision has been increasingly attracting the attention of researchers in recent years due to some of its perceived advantages over 2D vision. Among those advantages is its comparative higher accuracy and invariance (or tolerance) to illumination and scale variations that pose challenges to 2D vision. Additionally, the effects of rotation/viewpoint variations are potentially better alleviated in 3D vision. This interest has been further fueled by the more recent availability of the non-intrusive 3D digitizers that can provide considerable digitization accuracies, measurement densities and frame rates.

Matching of 3D surfaces is an essential part of many vision algorithms (e.g., recognition and classification) which is decisive to their overall accuracy, efficiency and robustness. The 3D surface matching approaches in the prior art have high computational complexity (accuracy is traded off with efficiency). For example, the well-known iterative closest point (ICP) algorithm described in P. J. Besl and N. D. McKay, “Method for registration of 3-d shapes,” in Robotics-DL tentative, International Society for Optics and Photonics, 1992, pp. 586-606, derives its strength from its ability to cater for the rigid transformations in an iterative manner which also is the source of its high computational complexity. Clearly, there is a niche in the prior art for approaches that simultaneously achieve these qualities. This is particularly of importance for the real-time applications that require high accuracies, especially for the currently available dense and high frame rate 3D videos.

The approaches to 3D surface matching can be categorized into two main categories according to the size of the surface considered in the matching relative to the digitized surface of the object/scene; namely, the global and the local surface matching. The utilization of all the surface of interest (global matching), on one hand, could have positive impacts on the matching. On the other hand, the global matching is sensitive to occlusions and clutter and requires the segmentation of the surface of interest. The segmentation errors and the presence of occlusions and clutter could ultimately undermine the matching accuracy and robustness. In contrast, the local approaches are robust to occlusions and clutter and do not require surface segmentation from the background. The selection of which local surface to match can be in some situations problem dependent, as described in T. Elguebaly and N. Bougila, “Generalized gaussian mixture models as a nonparametric bayesian approach for clustering using class-specific visual features,” Journal of visual communication and image representation, vol. 23, no. 8, pp. 1199-1212, 2012, and N. Bougila, K. Almakadmeh, and S. Boutemedjet, “A finite mixture model for simultaneous high-dimensional clustering, localized feature selection and outlier rejection,” Expert systems with applications, vol. 39, no. 7, pp. 6641-6656, 2012 or generally can be on the basis of key-points detected on the surface, the paradigm of key-points detection and extraction of local descriptors around them.

Practical approaches to 3D surface matching should address rotation variations among the surfaces being matched. They can be generally categorized based on the stage at which the rotation variations are addressed. In a first category, 3D surfaces are rigidly transformed (rotations and translations) to a standard home orientation (i.e., orientation normalization) at an early stage, for example at the preprocessing stage. The approaches are then subject to less constraints at the subsequent stages, particularly at the feature extraction stage which potentially results in more informative features. Most widely used approaches to orientation/pose normalization are on the basis of the principal directions of the surfaces as described in: D. V. Vranic, “An improvement of rotation invariant 3d-shape based on functions on concentric spheres,” Proceedings of International Conference on Image Processing, vol. 3, pp. 111-757, 2003, H. Dutagaci, B. Sankur, and Y. Yemez, “Subspace methods for retrieval of general 3d models,” Computer vision and image understanding, vol. 114, no 8, pp. 865-886, 2010, and A. S. Mian, M. Bennamoun, and R. Owens, “An efficient multimodal 2d-3d hybrid approach to automatic face recognition,” IEEE Transactions on Pattern Analysis and Machine Intelligence, vol. 29, no. 11, pp. 1927-1943, 2007. The principal directions are applicable to a large number of surface classes both 2.5D and closed. They are also used for local surfaces described in A. S. Mian, M. Bennamou, and R. Owens, “Keypoint detection and local feature matching for textured 3d face recognition,” International Journal of Computer vision, vol. 79, no. 1, pp. 1-12, 2008. However, they are not sufficiently accurate due to occlusions (including self-occlusions), resolution variations, cropping errors, deformations of the surfaces and/or the lack of prominent principal directions (For example, for near spherical or ellipsoidal surfaces). Surfaces are also normalized by fitting to a plane as described in C. S. Chua and R. Jarvis, “Point signatures: A new representation for 3d object recognition,” International Journal of Computer Vision, vol. 25, no. 1, pp. 63-85, 1997, C. S. Chua, F. Han, and Y. K. Ho, “3d human face recognition using point signature,” in proceeding of fourth IEEE international conference on Automatic Face and Gesture recognition, pp. 233-238, 2000, F. Al-Osaimi, M. Bennamoun, and A. Mian, “Interest-point based face recognition from range images,” in British machine vision conference, 2007, and D. Colbry and G. Stoclkman, “Canonical face depth map: A robust 3d representation for face verification,” IEEE conference on Computer Vision and Pattern Recognition, pp. 1-7, 2007 or registering to a standard surface as the average face as described in B. Gokberk and L. Akarun, “Comparative analysis of decision level fusion algorithms for 3d face recognition,” 18^{th} International Conference on in Pattern Recognition, vol. 3, IEEE, pp. 1018-1021, 2006.

Other methods make use of surface landmarks in the normalization as described in K. J. Chang, K. W. Bowyer, and P. J. Flynn, “Effects on facial expression in 3d face recognition,” in Defense and Security, International Society for Optics and Photonics, 2005, pp. 132-143, from which a new coordinate system can be derived. Generally, the orientation normalization methods lack the accuracy and/or the robustness which may adversely affect the surface matching as described in M. Kazhdan, T. Funkhouser, and S. Rusinkiewicz, “Rotation invariant spherical harmonic representation of 3d shape descriptors,” in Proceedings of the 2003 Eurographics/ACM SIGGRAPH symposium on Geometry processing, Eurographics Association, 2003, pp. 156-164, and M. Kazhdan, “An approximate and efficient method for optimal rotation alignment of 3d models,” IEEE Transactions on Pattern Analysis and Machine Intelligence, vol. 29, no. 7, pp. 1221-1229, 2007.

In a second category, in which most approaches fall, the invariance to rotations is addressed through the extraction of invariant features. Like those in the first category, the extraction of such features provides dimensionality reduction which facilitates scalable surface matching. Their discriminativeness, robustness and/or matching performance vary from one approach to another. It is noticeable that features in this category trade-off their completeness and high discriminativeness with rotation invariance. A substantial number of approaches in this category are based on histograms as described in G. Hetzel, B. Leibe, P. Levi, and B. Schiele, “3d object recognition from range images using local feature histograms,” Proceedings of the 2001 IEEE computer society conference on Computer vision and Pattern Recognition, vol. 2, pp. 11-394, S. Belongie, J. malik, and J. Puzicha, “Shape matching and object recognition using shape contexts,” IEEE Transactions on Pattern analysis and Machine Intelligence, vol. 24, no. 4, pp. 509-522, 2002, M. Kortgen, G. J. Park, m. Novotni, and R. Klein, “3d shape matching with 3d shape contexts,” in the 7^{th} central European seminar on computer graphics, vol. 3, 2003, pp. 5-17, R. B. Rusu, N. Blodow, and M. Beetz, “Fast point feature histograms (fpfh) for 3d registration,” IEEE International Conference on Robotics and Automation, pp. 3212-3217, 2009, H. Skibbe, M. Reisert, and H. Burkhardt and M. Himmlsbach, “Shog-spherical hog descriptors for rotation invariant 3d object detection,” Pattern recognition, Springer (2011), pp 142-151, T. Luettel, and H. J. Wuensche, “Real-time object classification in 3d point clouds using point feature histograms,” IEEE/RSJ International Conference on Intelligent Robots and Systems, pp. 994-1000, 2009 or distributions as described in R. Osada, T. Funkhouser, B. Chazelle, and D. Dobkin, “Matching 3d models with shape distributions,” in SMI2001 International Conference on Shape Modeling and Applications, IEEE, 2001, pp 154-166, and O. C. Hamsici and A. M. Martinez, “Rotation invariant kernels and their application to shape analysis,” IEEE Transactions on Pattern Analysis and Machine Intelligence, vol. 21, no. 11, pp. 1985-1999, 2009, of different geometric aspects such as the surface normals, gradients, curvatures and/or point coordinates.

Some of the most well-known approaches such the spin image described in A. E. Johnson and M. Hebert, “Using spin images for efficient object recognition in cluttered 3d scenes,” IEEE Transactions on Pattern Analysis and Machine Intelligence, vol. 21, no. 5, pp. 433-449, 1999, and the Scale Invariant Feature Transform (SIFT) described in D. G. Lowe, “Object recognition from local scale-invariant features,” Proceedings of the seventh IEEE international conference on Computer vision, vol. 2, pp. 1150-1157, 1999 and D. G. Lowe, “Distinctive image features from scale-invariant key-points,” International journal of computer vision, vol. 60, no. 2, pp. 91-110, 2004, which was extended to the 3D matching in P. Scovanner, S. Ali, and M. Shah, “A 3-dimensional sift descriptor and its application to action recognition,” in Proceedings of the 15^{th} international conference on Multimedia, A C M, 2007, pp. 357-360 and in T. W. R. Lo and J. P. Siebert, “Local feature extraction and matching on range images: 2.5d sift,” Computer Vision and Image Understanding, vol. 113, no. 12, pp. 1235-1250, 2009 which are histogram-based. Whereas most these approaches are inexpensive to compute, significant information loss is common to them due to the ambiguity of histograms/distributions.

3D moments based methods such as described in N. Canterakis, “3d Zernike moments and Zernike affine invariants for 3d image analysis and recognition,” 11th Scandinavian Conf. on Image Analysis, Citeseer (1999), and D. Xu, and H. Li, “3d surface moment invariants,” International Conference on Pattern Recognition, vol. 4, pp 173-176, 2006, can be complete up to the considered order. However, higher order moments are numerically ill-conditioned as explained in R. Kakarala, and D. Mao, “A theory of phase-sensitive rotation invariance with spherical harmonic and moment-based representations, IEEE Conference on Computer Vision and Patter recognition, pp. 105-112, 2010. Markov random fields (MRFs) are used to extract auto-regression parameters (features) of texture pixels on circles (2D images) as described in H. Deng, and D. A. Clausi, “Gaussian mrf rotation-invariant features for image classification,” IEEE Transactions on Pattern Analysis and Machine Intelligence, vol. 26, 2004, pp. 951-955. These features are incomplete representations and they are only invariant to in-plane rotation.

In a considerable number of approaches, the spherical harmonics are used for 3D model/surface matching as described in J. C. Carr, R. K. Beatson, J. B. Cherrie, T. J. Mitchell, W. R. Fright, B. C. McCallum, and T. R. Evans, “Reconstruction and representation of 3d objects with radial basis functions,” in Proceedings of the 28^{th} annual conference on computer graphics and interactive techniques, ACM, 2001, pp. 67-76, particularly in 3D model retrieval. The harmonic coefficients are dependent on the orientation of the surface. Some of these approaches normalize the orientation of the surfaces/models prior to the extraction of the spherical harmonics as described in P. Papadakis, I. Pratikakis, S. Perantonis, and T. Theoharis, “Efficient 3d shape matching and retrieval using a concrete radialized spherical projection representation,” Pattern Recognition, vol. 40, no. 9, pp. 2437-2452, 2007. Others achieve invariance by relying only on the magnitudes of the harmonics, by summing the magnitudes of the harmonics in each band as described in Q. Wang, O. Ronneberger, and H. Burkhardt, “Rotational invariance based on Fourier analysis in polar and spherical coordinates,” IEEE Transactions on Pattern Analysis and Machine Intelligence, vol. 31, no. 9, pp. 1715-1722, 2009. Such approaches are considered 3D extension of the Fourier descriptors. They similarly do not take advantage of the important phase information. A third group of approaches based on the spherical harmonics defers the rotation invariance to a late matching stage (the third category). This creates an over-head with each pair of surfaces being matched, which may limit their scalability to a large number of galleries or reference surfaces.

The maximum correlation method based on Wigner D-matrix along with Fourier transform is used to compute the correlation in the frequency domain described in H. Skibbe, Q. Wang, O. Ronneberger, H. Burkhardt, and M. Reisert, “Fast computation of 3d spherical Fourier harmonic descriptors a complete orthonormal basis for a rotational invariant representation of three-dimensional objects,” IEEE 12^{th} International Conference on Computer Vision Workshops, pp. 1863-1869, 2009. These approaches overcome the limitation of the phase information loss. However, it is impractical to employ spherical harmonics in the representation of surfaces up to high band harmonics that are capable of capturing surface details, evident from surface reconstruction. As the spherical harmonics are extracted from the functions defined by the intersection of spheres with the 3D model, their 2D equidistance sampling is particularly difficult (the problem of Fejes Toth). Usually, these spheres are placed at the mass centers of surfaces/models which is 3 not reliable enough for high accuracy surface recognition and classification. Furthermore, these approaches rely on an approximate (inaccurate) sampling.

Relevant to the spherical harmonics, the approach of equivariant filters (polar harmonics) learns the filters behavior to achieve in-plane rotation invariance as described in K. Liu, Q. Wang, W. Driever, and O. Ronneberger, “2d/3d rotation invariant detection using equivariant filters and kernel weighted mapping,” Conference on Computer Vision and Pattern Recognition (CVPR), IEEE, pp. 917-924, 2012. Methods based on the filtering of 3D range images are likely affected by the out-of-the-plane rotations and additionally involve information loss. In the point signature approach, a single sphere is intersected with the 3D surface to form a 3D curve which is then fitted to a plane. The 3D curve is next projected onto the plane to form a planar curve. The planar curve is sampled at equal angular steps around the plane normal at the central point. Rotational invariance is achieved either by orienting the curve according to the local maximum of the curve (first category) or by resorting to the maximum correlation between the planar curves if there is no detectable local maximum (third category). Whereas that approach has provided a simple and efficient approach to curve sampling, both the plane fitting and the normalization according to the local maxima could have adverse effects on its accuracy and robustness. For example, there is no guarantee that the planar curve will not be self-intersecting and/or of certain non-convex curve types that undermine the sampling. The most prominent surface matching approaches in the third category are those based on surface registration based on iterative closest point (ICP) algorithm as described in C. Yang and G. Medioni, “Object modelling by registration of multiple range images,” Image and vision computing, vol. 10, no. 3, pp. 145-155, 1922 and K. I. Chang, W. Bowyer, and P. J. Flynn, “Multiple nose region matching for 3d face recognition under varying facial expression,” IEEE Transactions on Pattern Analysis and Machine Intelligence, vol. 28, no. 10, pp. 1695-1700, 2006. The dissimilarity measures are usually extracted from the registration error (from the whole considered surface).

What is needed, as recognized by the present inventor, is a local surface matching approach that achieves utmost accuracy, robustness, efficiency and scalability.

The foregoing “background” description is for the purpose of generally presenting the context of the disclosure. Work of the inventor, to the extent it is described in this background section, as well as aspects of the description which may not otherwise qualify as prior art at the time of filing, are neither expressly or impliedly admitted as prior art against the present invention. The foregoing paragraphs have been provided by way of general introduction, and are not intended to limit the scope of the following claims. The described embodiments, together with further advantages, will be best understood by reference to the following detailed description taken in conjunction with the accompanying drawings.

### SUMMARY

The present disclosure relates to a three-dimensional (3D) local surface matching representation system and associated methodology that extracts a treble of 3D profiles from data corresponding to a 3D local surface wherein the treble of the 3D profiles includes a central profile and two adjacent profiles, calculates a scalar sequence pair based on the treble of the 3D profiles, calculates adjustable integral kernels based on the scalar sequence pair, and provides the adjustable integral kernels to pattern recognition applications.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of a 3D local surface matching representation system according to one example;

FIG. 2 is a schematic that shows sample profiles according to one example;

FIG. 3 is a schematic that shows profile trebles according to one example;

FIG. 4 is a graph that shows exemplary sequence pairs according to one example;

FIG. 5 is a flow chart for 3D local surface matching representation according to one example;

FIG. 6 is a schematic that shows exemplary key-points according to one example;

FIG. 7 is a schematic that shows graphs of the cumulative matching characteristic (CMC) and the receiver operating characteristic (ROC) according to one example;

FIG. 8 is a schematic that shows exemplary CMC curves according to one example;

FIG. 9 is a schematic that shows exemplary ROC curves according to one example;

FIG. 10 is a schematic that shows exemplary CMC curves according to one example;

FIG. 11 is a schematic that shows exemplary ROC curves according to one example;

FIG. 12 is a schematic that shows exemplary Face Recognition Grand Challenge (FRGC) ROC I, ROC II, and ROC III curves according to one example;

FIG. 13 is an exemplary block diagram of a computer according to one example;

FIG. 14 is an exemplary block diagram of a data processing system according to one example; and

FIG. 15 is an exemplary block diagram of a central processing unit according to one example.

### DETAILED DESCRIPTION

Referring now to the drawings, wherein like reference numerals designate identical or corresponding parts throughout several views, the following description relates to a matching representation of local 3D surfaces system and associated methodology for key-points detection.

The method of the present disclosure has the advantage of providing a faithful representation to the local 3D surfaces even under surface deformations, in the sense that the deformations do not induce errors in the representation but rather the deformations are encoded in the representation. Therefore, surface matching can be conducted as scalable template matching without the limitations associated with template matching, i.e., requiring accurate cropping and normalization. The representation supports reliable modeling of the surface deformations. The representation is complete and its matching sensitivity to the embedded information is adjustable. The representation can be numerically varied to better capture certain aspects of an underling 3D surface. This combination of completeness and adjustability, enhance the discriminability of the representation and improve the matching accuracy and robustness. In addition, high accuracy and robustness are enforced throughout the extraction and computation steps of the representation.

The method of the present disclosure handles rotation invariance before feature extraction. However, unlike other methods (which keep the same type of representation), it accurately and robustly converts the surface into an invariant intermediate representation.

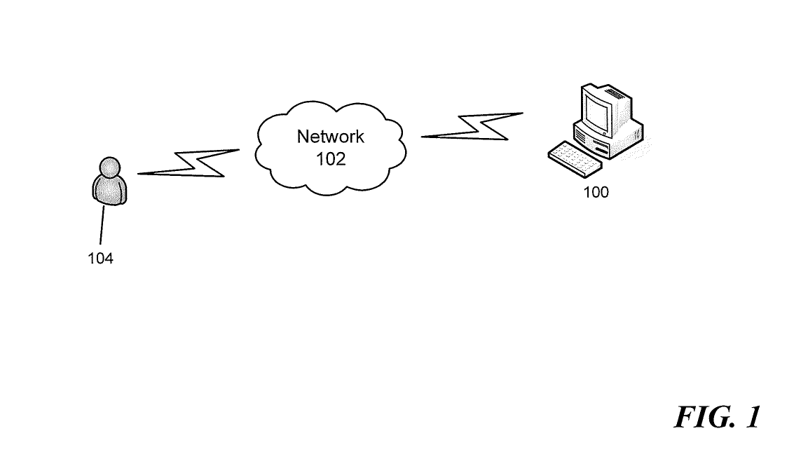

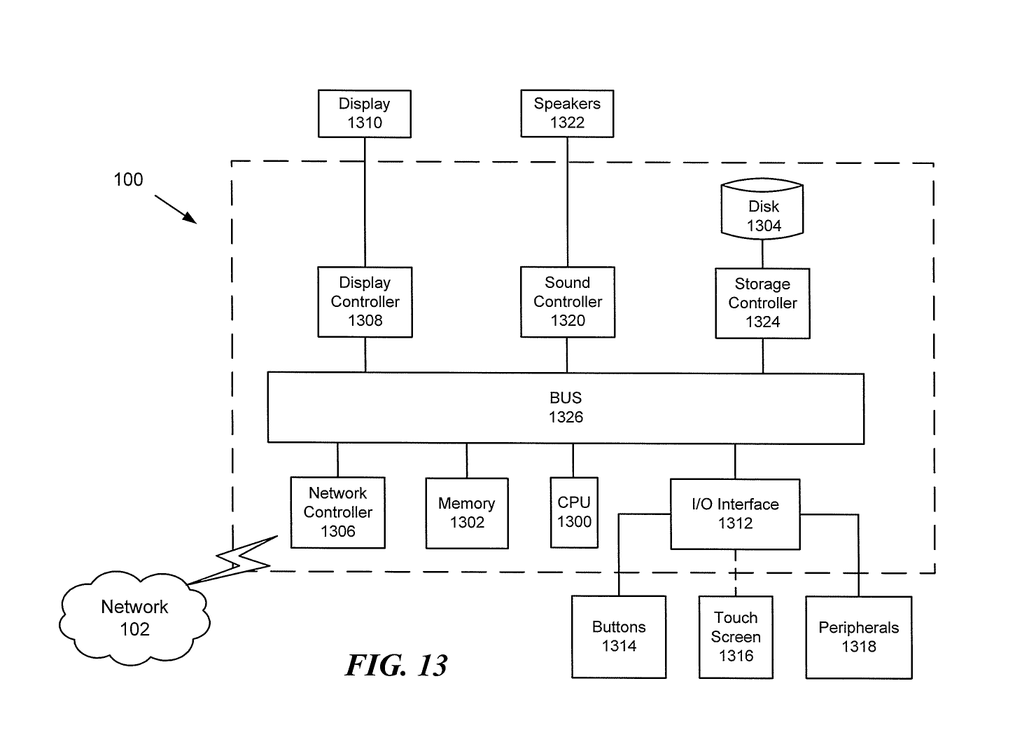

FIG. 1 is a schematic diagram of a 3D local surface matching representation system according to one example. The system may include a computer 100 and a network 102. The computer 100 may receive via the network 102 a 3D local surface. In one embodiment, the 3D local surface may be represented as a one-channel range image I, a 2D matrix. The horizontal index of I is linearly related to the x coordinate, the vertical index is linearly related to the y coordinate, and the image values represent the z coordinates. Holes in the surface are filled by interpolation. In one embodiment, a user 104 may send via the network 102 the 3D local surface. In other embodiments, the 3D local surface may be sent by host applications. The host applications may include pattern recognition applications. The network 102 is any network that allows the computer 100 and the user 104 to communicate data with each other such as a Wide Area Network, Local Area Network, or the Internet. The computer 100 may include a CPU 1300 and a memory 1302 as shown in FIG. 13. In one embodiment, the image may be captured by an image-capturing device. The image-capturing device may include one or more image sensors. The image sensors may be charge-coupled devices (CCD), complementary metal semiconductors (CMOS), or the like. The image sensors may generate an analog signal. The analog signal is then converted into digital values by an analog-to-digital converter. In this manner, the image may be captured in a digital format that may define the image. The image-capturing device may include but not limited to a digital still camera, a digital video camera, a cellular telephone, a personal data assistant, security cameras, or a document indexing system. The system may also receive the image using a scanner, or a fax machine, or a combination color printer/scanner/fax machine.

The matching representation described herein is a collection of 3 Degrees of Freedom (DoF) Rotation-invariant and Adjustable Integral Kernels (RAIKs) determined from a surface patch around a point p on the 3D surface. A treble of profiles is first determined by the CPU 1300. The treble of profiles may include a central profile and two adjacent profiles. The local surface is intersected with concentric spheres of increasing radii, R_{i=1 . . . 3N}, where their common center is placed at the point p. The intersection of each sphere Rᵢ with the surface results in a closed 3D curve (the central profile), Cᵢ. The resulting curves are then sampled based on equal geodesic distances on the surface of the spheres rather than the local surface as it can be more reliably and efficiently determined due to the simple geometry of the sphere. The sampling provides a predetermined number of samples n in an iterative process (but fast and quickly convergent), as the lengths of the profiles vary according to the underlying 3D local surface as explained below. At this stage, the sampled profiles are still dependent on the surface orientation. The samples of each central profile Cᵢ are then corresponded to those of a first adjacent profile Cᵢ₋₁ (intersection with the sphere Rᵢ₋₁) and to those of a second adjacent profile Cᵢ₊₁ (intersection with the sphere Rᵢ₊₁), i.e., each set of three consecutive and adjacent profiles are corresponded, the details are described below. From each set of three consecutive profiles, a pair of 2 DoF rotation invariant sequences S_{i,1} and S_{i,2} of real numbers is then determined as described below. An adjustable integral kernel Kᵢ is then determined from the sequence pair Sᵢ as described below. The pair Sᵢ captures all the information in the part of the surface patch between the corresponded profiles Cᵢ₋₁ and Cᵢ₊₁ which is also completely encoded in the integral kernel, Kᵢ. Assuming that the sequence S_{i,1} is known and using the kernel Kᵢ, the sequence S_{i,2} can be precisely predicted. Starting from the most inner sequence S_{1,1}, the remaining sequences can be recursively predicted in outward direction. This shows that the overall local surface representation is complete apart from the initial sequence S_{1,1}. If the initial sequence is extracted using a sphere that has a near zero radius, then the information contained in the sequence is minimal. Theoretically, it reduces to the principal curvatures of the surface at the point p, which do not need to be determined.

The central profile Cᵢ, may be extracted by intersecting a first sphere Rᵢ with fitted bicubic functions to the 3D surface at the intersection locations. A second sphere rᵢ with a smaller radius than the radius of the first sphere, is used to sample the profile at equally spaced distances. The center of the second sphere rᵢ is placed at an initial sample s_{i,} on the central profile Cᵢ. The intersection of the second sphere rᵢ with the central profile Cᵢ results in two points of intersection sₐ and S_{b}, where the center of rᵢ (or the initial sample s_{i,1}) is in between. One of these intersection points may be considered as a new profile sample. The process is repeated, by the CPU 1300, in the same direction until the initial sample is reached (the curve is closed), i.e., the second sphere rᵢ is placed at the new sample and the selection of an intersection point as the next sample is kept consistent. The initial sample on the profile can be any arbitrary point. In one embodiment, the initial sample is determined by intersecting the range curve corresponding to the 2D line segment in the range image I emanating horizontally to the right direction from the center of the large sphere Rᵢ with the closed profile.

The bicubic fitting may be performed using range image UV mapping, where the mapping variables u and v are linearly related to the x and y coordinates (x=ku+c₁ and y=kv+c₂). The bicubic function as expressed in equation (1) is fitted to a 4×4 range pixel surface patch with its own ū−\hat{v} mapping. The û and \hat{v} mapping variables may be chosen to range from −1 to 2. Other ranges may be used. The image (absolute) u−v mapping is related to the patch û−\hat{v} mapping and the image location of the 4×4 patch (ũ, \tilde{v}), which corresponds to the point (0, 0) in the patch mapping, as expressed in equation (2) and (3).

$$\begin{matrix}z ( u , v ) = {\sum }_{i = 0}^{3} {\sum }_{j = 0}^{3} {a}_{ij} {\hat{u}}^{i} {\hat{v}}^{j} & ( 1 ) \\ u = \tilde{u} + \hat{u} & ( 2 ) \\ v = \tilde{v} + \hat{v} & ( 3 )\end{matrix}$$

To find another profile sample, the CPU 1300 may determine the location of the fitting patch such that the current sample is roughly in the middle (ũ=└u┘, \tilde{v}=└v┘), û ε[0,1[and \hat{v} ε[0,1[. To ensure that the fitted bicubic functions are used as an interpolation (rather than extrapolation), the radius of the second sphere is taken to be less than one (rᵢ≦1) and the fitting patch is shifted as needed to make the new sample in the previously specified intervals. For metrically larger sampling spheres, the range image is down-sampled and equivalently rᵢ is kept less than or equal to one. By the virtue of the linear relationship between the mapping variables and the x and y coordinates of the range pixels, the bicubic fitting involves only a multiplication of a 16×16 matrix by a vector of dimensionality 16, the vectorization of the depth measurements of the square patch z. A matrix M is populated with the values of ûⁱ \hat{v}^{j} to reflect equation (1) in z=Ma, where the bicubic fitting is a=M⁻¹z (the matrix may be inverted off-line as it is independent of the range values). The vector a represents fitting parameters. For the sampling and the extraction of the profile, the two simultaneous equations (4) and (5) are solved numerically for ûⱼ₊₁, and \hat{v}ⱼ₊₁, where u₀, v₀ and z₀ are respectively the UV variables and the z coordinate of the center of the sphere Rᵢ, point p. The variables ûⱼ, \hat{v}ⱼ and z(ûⱼ, \hat{v}ⱼ) are for the current sample.

ƒ₁(ûⱼ₊₁,\hat{v}ⱼ₊₁)=(ũⱼ₊₁+ũⱼ₊₁−u₀)²+(\tilde{v}ⱼ₊₁+\hat{v}ⱼ₊₁−v₀)²+(z(û_{z+1},\hat{v}ⱼ₊₁)−z₀)²−Rᵢ²=0 (4)

ƒ₂(ûⱼ₊₁,\hat{v}ⱼ₊₁)=(ûⱼ₊₁−ûⱼ)²+(\hat{v}ⱼ₊₁−\hat{v}ⱼ)²+(z(ûⱼ₊₁,\hat{v}ⱼ₊₁)−z(ûⱼ,\hat{v}ⱼ))²−rᵢ²=0 (5)

The numerical method used for the solution is a combination of the multidimensional and unidimensional Newton root finding methods. Other numerical methods may be used as would be understood by one of ordinary skill in the art. The multidimensional Newton method, [Δûⱼ₊₁, Δ\hat{v}ⱼ₊₁]^{T}=−J⁻¹[ƒ₁(ûⱼ₊₁, \hat{v}ⱼ₊₁), ƒ₂(ûⱼ₊₁, \hat{v}ⱼ₊₁)]^{T}, has a fast convergence speed but sometimes may diverge. In one embodiment, the CPU 1300 may apply the multidimensional Newton method iteratively at a first step for efficiency, as a close initial solution can be determined from the previous samples [2ûⱼ−ûⱼ₋₁, 2\hat{v}ⱼ−vⱼ₋₁]^{T}.

When the fitting patch is shifted between the samples, their UV parameters are translated to the current patch mapping. Whenever the multidimensional method diverges from the last solution estimate (i.e., |ƒ_{1,k}ƒ_{2,k}|>|ƒ_{1,k-1}ƒ_{2,k-1}|), a sequence of two downhill steps on the basis of the unidimensional Newton method along the gradient direction,

$$g = {[ \frac{\partial f}{\partial \hat{u}} , \frac{\partial f}{\partial \hat{v}} ]}^{T} ,$$

is performed independently on ƒ₁ as expressed in equation (4),

$${[ Δ {\hat{u}}_{j + 1} , Δ {\hat{v}}_{j + 1} ]}^{T} = {[ \frac{- {f}_{1} \frac{\partial {f}_{1}}{\partial u}}{{\vert {g}_{1} \vert}^{2}} , \frac{- {f}_{1} \frac{\partial {f}_{1}}{\partial v}}{{\vert {g}_{1} \vert}^{2}} ]}^{T}$$

followed by two other steps for ƒ₂ (as expressed in equation (5)). The CPU 1300 may check whether the method has diverged. In response to determining that the method has not diverged, the multidimensional iterations are resumed. In response to determining that the method has diverged, the unidimensional steps are continued.

The unidimensional steps, which may not be as effective as the multidimensional ones, are not often needed but are used to recover the multidimensional solution from divergent situations. On average, the CPU 1300 finds a solution in very few iterations with high accuracy (e.g., in the order of 10-7 of the pixel resolution).

As the aim is to produce the profile Cᵢ with n samples that are equally spaced, the value of the radius rᵢ that achieves that is determined by iteratively computing the geodesic distance of the profile as expressed in equation (6) and estimating r_{i,k} that produces the correct number of samples using equations (7) and (8). The initial r_{i,1} is roughly estimated as 2πRᵢ/n or that of an adjacent profile.

$$\begin{matrix}{L}_{k} = 2 {R}_{i} [ ( {n}_{k} - 1 ) arcsin ( \frac{{r}_{i , k}}{2 {R}_{i}} ) + arcsin ( \frac{{d}_{i , k}}{2 {R}_{i}} ) ] & ( 6 ) \\ {r}_{k}^{′} = 2 {R}_{i} sin ( \frac{{L}_{k}}{2 n {R}_{i}} ) & ( 7 ) \\ {r}_{i , k + 1} = {r}_{i , k} + λ ( {r}_{k}^{′} - {r}_{i , k} ) & ( 8 )\end{matrix}$$

λ is a parameter in the range]0, 1] and d_{i,k} is the Euclidean distance between the first and the last samples at the k-th iteration. For fast convergence, a 2 value of one is attempted in the first iterations as it aims to provide an immediate prediction of r_{i,k+1}. In most cases, the iterative approach converges in two or three iterations using such value of k. The CPU 1300 may check whether the estimation diverges (i.e., |r_{i,k}−r_{i,k-1}|>|r_{i,k}−r_{i,k-2}|). In response to determining that the estimation diverges, more gradual predictions of λ are attempted,

$$λ = \frac{1}{2} , \frac{1}{4} , \frac{1}{8} , and \frac{1}{16} ,$$

starting from large to small values of λ. The values of λ may be stored in the memory 1302. The iterative approach is halted when the number of the samples nₖ₊₁=n and the distance d_{i,k+1}≈r_{i,k+1} or when rₖ₊₁=n+1 and d_{i,k+1}≈0. In the latter case, the last sample is dropped because of its proximity to the first sample (it represents the first sample).

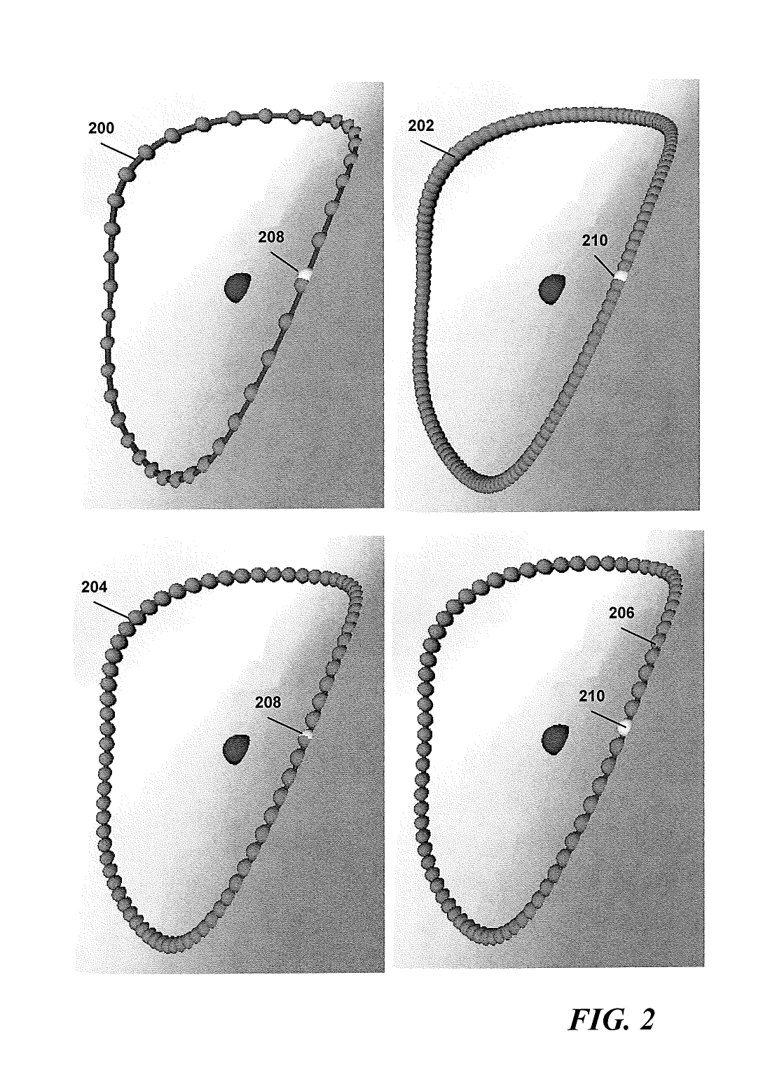

FIG. 2 is a schematic that shows sample profiles according to one example. FIG. 2 shows a 120-sample profile sampled using the method described herein. A first profile 200 is sampled using a first initial sampling sphere. A dot mark 208 represents the initial sample of the first profile 200. A second profile 202 is sampled using a second initial sphere. The second dot mark 210 represents the initial sample of the second profile 202. The first profile 200 converges to a third profile 204 in two iterations. The second profile 202 converges to a fourth profile 206 in two iterations. Note the extra sample in the third profile 204 almost superimposing the initial sample 208.

As described above, the correspondence of the samples of each of three adjacent profiles is determined. The correspondence of the profile samples may be determined according to their order of appearance in the profiles Cᵢ₋₁, Cᵢ and Cᵢ₊₁, which can result in drifts among the corresponded samples because of the differences among the sampling spheres (rᵢ₋₁, rᵢ, and rᵢ₊₁). That is, the distances among the corresponded samples may unacceptably increase due to the shifts along the profiles due to the changes in sphere radii Rᵢ₋₁, Rᵢ, and Rᵢ₊₁. Consequently, the discriminability of the matching representation may be undermined.

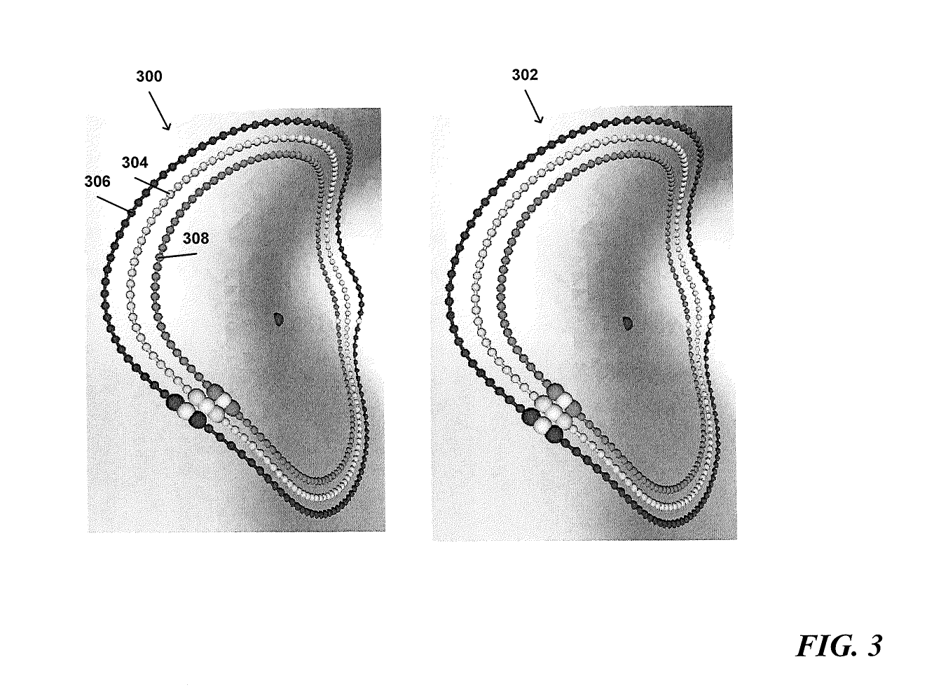

FIG. 3 is a schematic that shows profile trebles according to one example. FIG. 3 shows a first profile treble 300 and a second profile treble 302. The first profile has a central profile 304 and two adjacent profiles 306,308. The first profile treble is sampled independently as described above. The first profile treble 300 has large draft among their samples.

To avoid this problem, only the central profile, Cᵢ, is extracted using the method described above. The other two profiles are extracted by first finding the planes perpendicular to Cᵢ at each of its samples. The planes are then intersected with the spheres Rᵢ₋₁=Rᵢ−h and Rᵢ₊₁=Rᵢ+h and also with the 3D surface, resulting in a corresponded point of intersection for each of the two spheres around each central profile sample. The parameter h is a fixed small difference in the radii of the profile spheres. This approach keeps the samples of the central profile equally spaced and spreads the distance variations appropriately for the other two profiles by the CPU 1300. The extraction of each corresponded sample treble is achieved by numerically solving two simultaneous equation systems. Let the vector tᵢⱼ be the tangential unit vector of the profile Ci at the j-th sample and the vector nᵢⱼ be the normal unit vector to the sphere Rᵢ at the same sample (can be reliably determined). The two vectors are perpendicular. Thus, the estimation error of t_{i,j}′ from the adjacent samples can be mitigated by removing the non-perpendicular component,

$${t}_{i , j} = \frac{{t}_{i , j}^{′} - {t}_{i , j}^{′ T} {n}_{i , j} {n}_{i , j}}{‖ {t}_{i , j}^{′} - {t}_{i , j}^{′ T} {n}_{i , j} {n}_{i , j} ‖} .$$

The vector s_{i,j} represents the j-th sample of the central profile, s_{i,j}=[û_{i,j} \hat{v}_{i,j} \hat{z}(û_{i,j} \hat{v}_{i,j})]^{T} and similarly, s_{i-1,j}=[û_{i-1,j} \hat{v}_{i-1,j} \hat{z}(û_{i-1,j}, \hat{v}_{i-1,j})]^{T} is for the corresponded sample on Cᵢ₋₁. The system of equations (9) and (10) is solved, by the CPU 1300, as described above for the independent variables û_{i-1,j} and \hat{v}_{i-1,j}.

(ũ_{i,j}+û_{i-1,j}−u₀)²+(\tilde{v}_{i,j}+\hat{v}_{i-1,j}−v₀)²(z(û_{i-1,j},\hat{v}_{i-1,j})−z₀)²−(Rᵢ−h)²=0 (9)

t_{i,j}^{T}(s_{i-1,j}−s_{i,j})=0 (10)

The third sample is found similarly by solving equations (11) and (12) for û_{i+1,j} and \hat{v}_{i+1,j}

(ũ_{i,j}+û_{i+1,j}−u₀)²+(\tilde{v}_{i,j}+\hat{v}_{i+1,j}−v₀)²(z(û_{i+1,j},\hat{v}_{i+1,j})−z₀)²−(Rᵢ+h)²=0 (11)

t_{i,j}^{T}(s_{i+1,j}−s_{i,j})=0 (12)

Both of the above two systems are solved using one bicubic fitting patch as discussed above, for accuracy and robustness. The central sample is similarly placed at the middle of the patch and the value of h is limited to the range]0, 1]. The initial values for the two systems are:

$${\hat{u}}_{i - 1 , j , k = 1} = {\hat{u}}_{i , j} - h \frac{{\hat{u}}_{i , j}}{‖ {S}_{i , j} ‖} and {\hat{v}}_{i - 1 , j , k = 1} = {\hat{v}}_{i , j} - h \frac{{\hat{v}}_{i , j}}{‖ {S}_{i , j} ‖}$$

for the first system and

$${\hat{u}}_{i + 1 , j , k = 1} = {\hat{u}}_{i , j} + h \frac{{\hat{u}}_{i , j}}{‖ {S}_{i , j} ‖} and {\hat{v}}_{i + 1 , j , k = 1} = {\hat{v}}_{i , j} + h \frac{{\hat{v}}_{i , j}}{‖ {S}_{i , j} ‖}$$

for the second system.

The second profile treble 302, shown in FIG. 3, is determined as described above. The method accurately samples and corresponds profile trebles.

From the corresponded profiles, C_{i-1,j}, C_{i,j}, and C_{i+1,j}, a 2 DoF rotationally invariant scalar sequence pair, S_{i,1} and S_{i,2}, is computed on the basis of difference vectors, d, among the corresponded samples and their cross product with the tangential vectors. The first sequence is extracted as expressed in equations (13)-(16):

d_{i,j,1}=s_{i-1,j}−s_{i,j} (13)

s_{i,j,1}=(d_{i,j,1}×t_{i,j})^{T}n_{i,j} (14)

s_{i,j,1}=(d_{i,j,1}^{⊥}×t_{i,j}+d_{i,j,1}^{μ}×tᵢⱼ)^{T}n_{i,j} (15)

s_{i,j,1}=(d_{i,j,1}^{⊥}×t_{i,j})^{T}n_{i,j} (16)

The second sequence is extracted by applying equations (17) and (18):

d_{i,j,2}=s_{i,j}−s_{i+1,j} (17)

s_{i,j,2}=(d_{i,j,2}×t_{i,j})^{T}n_{i,j} (18)

The 3D surface stripes from which the second scalar sequences, S_{i,2}, are extracted, can be represented by the unadjusted integral kernels K′ᵢ. The unadjusted kernel on the basis of circular convolution and with the knowledge of the previous sequence S_{i,1} can be used to determine (recover) the sequence S_{i,2} as expressed in equation (19). Because the circular convolution provides an additional 1 DoF invariance to the surface rotations, the integral kernel is 3 DoF rotationally invariant.

S_{i,2}=K′ᵢ*S_{i,1} (19)

The integral kernel can be efficiently computed, according to the discrete-time Fourier transform (DTFT), using the fast Fourier transform (FFT) algorithm as expressed in equation (20):

$${K}_{i}^{′} = {F}^{- 1} \{ \frac{F \{ {S}_{i , 2} \}}{F \{ {S}_{i , 1} \}} \} \qquad ( 20 )$$

While the integral kernel given by equation (20) is a complete representation of the underling surface, it is generally an inappropriate choice for two reasons. First, the kernel appears to be excessively sensitive to the high frequency variations of the surface and to the surface noise. Second, the phase values tend to be close to zero, particularly for the informative low frequencies. The latter, happens because the adjacency of the profiles results in a high degree of similarity among them. Since the division of complex numbers in equation (20) implies phase subtraction, the resulting phase information in K′ᵢ becomes attenuated. A more viable alternative is the adjustable kernel as expressed in equation (23).

$$\begin{matrix}‖ {K}_{i} ( ω ) ‖ = {[ ‖ \frac{{S}_{i , 1} ( ω )}{n} ‖ + ɛ ]}^{a} ‖ {S}_{i , 2} ( ω ) ‖ & ( 21 ) \\ arg ( {K}_{i} ( ω ) ) = β ⌊ arg ( {S}_{i , 2} ( ω ) ) - arg ( {S}_{i , 1} ( ω ) ) ⌋ & ( 22 ) \\ {K}_{i} = {F}^{- 1} \{ {K}_{i} \} & ( 23 )\end{matrix}$$

Where ∥.∥ is the frequency magnitude and arg(.) is the frequency phase. ε is a small positive number to avoid raising zero to a negative power. The adjusting parameters are α and β. In one embodiment, α is selected in the range [−1, 1] and β≧0. In the case of, α=−1 and β=1, the kernel is equivalent to that expressed by equation (20). For a higher value of α, the kernel sensitivity decreases. The parameter/scales the phase information.

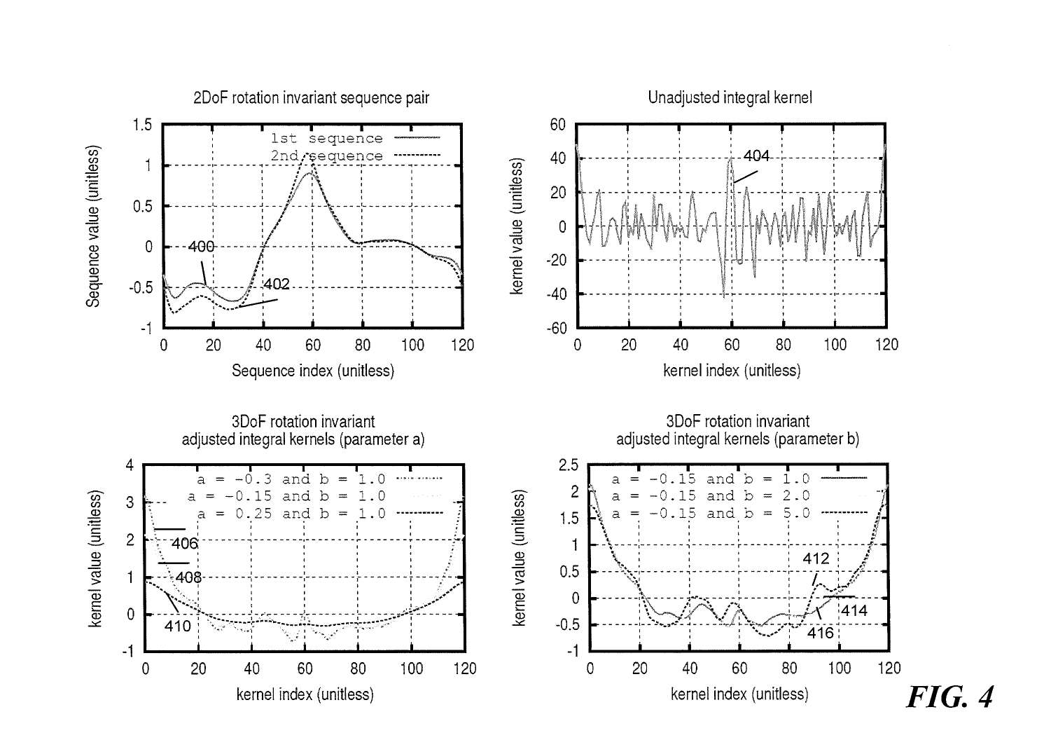

FIG. 4 is a graph that shows exemplary sequence pair according to one example. FIG. 4 shows a sequence pair extracted from the treble shown in FIG. 3, from which an unadjusted integral kernel and few adjusted integral kernels are extracted. Traces 400 and 402 show the 2 DoF rotation invariant sequence pair. Trace 400 shows the first sequence and trace 402 shows the second sequence. Trace 404 shows an unadjusted integral kernel. Traces 406, 408 and 410 show a 3 DoF rotation invariant adjusted integral kernels for different values of the adjusting parameters α and β. In traces 406, 408 and 410, β is equal to 1 and α is equal to −0.3, −0.15 and 0.25 respectively. Traces 412, 414, 416 show the 3 DoF rotation invariant adjusted integral kernels for a equals to −0.15 and 3 equals to 1,2 and 5 respectively.

The integral kernels K_{1, . . . , n} may be concatenated to form the matching representation (the 2D image), used in face recognition experiments, or may be integrated along the radial direction (radially-integrated), used in object classification experiments. In the latter approach, the i-th slice of the representing 2D image is the summation of the corresponding kernel and all the previous kernels, i.e., K_{1, . . . , i}.

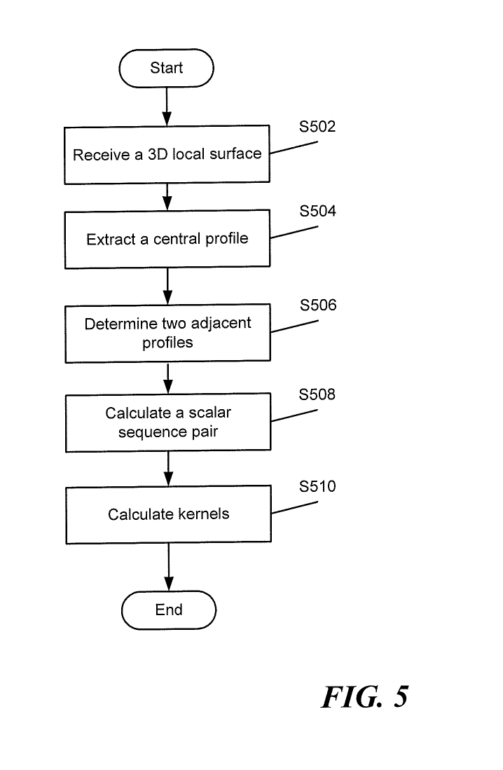

FIG. 5 is a flow chart for 3D local surface matching representation according to one example. At step S502, the computer 100 receives the 3D local surface from the user 104 or other applications. At step S504, the central profile is extracted. In one embodiment, the central profile is extracted, using the CPU 1300, by intersecting a first sphere with fitted bicubic functions to the 3D local surface. Then, the central profile may be sampled at equally spaced distance using a second sphere with a smaller radius than the first sphere. The center of the second sphere may be place on an initial sample on the central profile. The CPU 1300 checks whether the initial sample is reached. In response to determining that the initial sample is reached, the flow goes to step S506. In response to determining that the initial point is not reached, the sampling step is repeated as explained above. The sampling may be done by solving equations (4) and (5) as explained above. The initial sample on the profile can by any arbitrary point. At step S506, the two adjacent profiles are determined by the CPU 1300. The adjacent profiles are determined by first finding planes perpendicular to the central profile at each of its sample points as found at step S504. Then, the planes are intersected with spheres with radius equal R±h where R is the radius of the first sphere and h is a predetermined parameter. The predetermined parameter may be determined based on training data as would be understood by one of ordinary skill in the art. The first adjacent profile may be determined by solving equations (9) and (10). The second adjacent profile may be determined by solving equations (11) and (12). At step S508, the CPU 1300 may calculate a scalar sequence pair. In one embodiment, a first sequence may be determined by applying equations (13) and (14) and a second sequence by applying equations (17) and (18). At step S510, adjustable integral kernels based on the scalar sequence pair are calculated. In one embodiment, the adjustable integral kernels are determined by applying equation (20). In one embodiment, the adjustable integral kernels may be concatenated to form the matching representation. In one embodiment, the adjustable integral kernels are integrated along a radial direction.

In one embodiment, the method of the present disclosure may be used for key-points detection. Two approaches for key-points detection based on the integral kernels may be used. The two approaches determine sparser kernels than that normally used for local surface matching, which is more computationally efficient. The sparse kernels are computed as described in FIG. 5 from two or four profile trebles. The distance among the profiles of each treble, h, equals to that of the matching representation, however, the distances among the trebles are usually larger for the sparse kernels. Let K_{1, . . . , K} be the K integral kernels. In the exemplary results presented below, a K value of four is used for the static facial scans and a K value of two is used for the 3D object videos. At surface points, the scalar function expressed in equation (25) can be calculated based on the covariance matrices of the kernels, where kᵢ and k̅ are the i-th and the mean kernel vectors in the vectorial form. The matrix M may be formed by cascading the kernel vectors and subtracting their mean, M=[(k₁−k̅) . . . (kₖ−k̅)]:

$$\begin{matrix}D = {M}^{T} M & ( 24 ) \\ {f}_{p} ( u , v ) = \frac{1}{det ( D + γ I )} & ( 25 )\end{matrix}$$

The matrix D is only of K×K dimension (i.e., either 4×4 or 2×2) and in most cases is full-rank. It has all the non-zero singular values of the singular n×n covariance matrix MM^{T}. The determinant, which is more computationally efficient, equals the products of the singular values of D. Therefore, ƒₚ (u, v) is a function of the variations among the different kernels. Sometimes, the least singular values are close to zero, resulting in zero (or close to zero) determinants. For this reason, the product of the identity matrix with the parameter γ is added to D. Additionally, it results in a smoother function, particularly for larger γ values. A γ value of one was used in the exemplary results described below. The local maxima (preferable due to their better quality) and/or minima locations of ƒₚ(u, v) are considered as the key-points and saved in the memory 1302. The two approaches differ in their techniques for the detection of the local maxima. In one embodiment, the CPU 1300 searches more exhaustively for the key-points with high accuracy sub-pixel localization. This avoids excessive computations of ƒₚ (u, v) by utilizing a coarse-to-fine key-point detection. First, a regular point grid of an appropriate and manageable resolution is specified on the range image. Then, the CPU 1300 evaluates ƒₚ (u, v) at each point and the local maxima are found, by comparison against their 3×3 neighborhood.

The function ƒₚ(u, v) is then determined, by the CPU 1300, for each of the 3×3 local neighborhoods with a local maximum at double the resolution. The patch size becomes 5×5 with only 16 new computations of the function. Within the 5×5 patches, the new locations of the local maxima are found. The points which cannot be maintained (as maxima) at the new resolution are dropped by the CPU 1300. The points may be stored in the memory 1302 and updated by the CPU 1300, at each iteration. The process is iterated until an appropriate level of high accuracy sub-pixel localization is reached. It should be noted that excessive sub-pixel localization might reduce the detectability/repeatability of the key-points. Thus, a balance should be struck based on the application of the system described herein. The choice of the parameter α for the kernels has effects on key-points detection. The higher values of α results in smoother fp and fewer key-points and vice versa. The function ƒp should be smooth enough to avoid aliasing at the coarse resolutions. Thus, an appropriate value of α should be selected. The approach described above (first approach) is suitable for static 3D images for which higher detection accuracy and robustness of the key-points are required.

In one embodiment, the CPU 1300 may use a second approach for key-points detection. The second approach requires the localization of initial key-points, which may be coarsely localized. The initial key-points are either localized using a computationally inexpensive off-the-shelf key-point detection approach or simply a regular coarse grid of points is used instead. The regular grid can be sparser than that used in the first approach. The locations of the initial key-points are then corrected by searching for their nearest local maxima and/or minima of ƒₚ (u, v) using a modified version of the downhill simplex numerical optimization method as would be understood by one with ordinary skill in the art (also called Nelder-Mead). The downhill simplex method is more robust to noise than the optimization methods based on the gradient. In one embodiment, each initial key-point is enclosed in a relatively coarse simplex (an equilateral triangle). Unlike the regular downhill simplex method, the simplices do not expand (but they similarly can go through reflection, contraction and/or reduction steps). This is because the scope of the search is limited to the neighborhoods of the initial key-points. The centroids of the simplices of which the size fall below a threshold within a maximum number steps are considered the final locations of the key-points. Otherwise, the initial key-points are dropped by the CPU 1300. The second approach can provide a subpixel localization accuracy of key-points with a fewer number of evaluations of ƒₚ (u, v) than that of the first approach but the localization of the first approach is more reliable. An increase in the value of the adjusting parameter α results in more chances of finding local maxima near the initial key-points. This approach suits 3D videos as real-time performance can be supported.

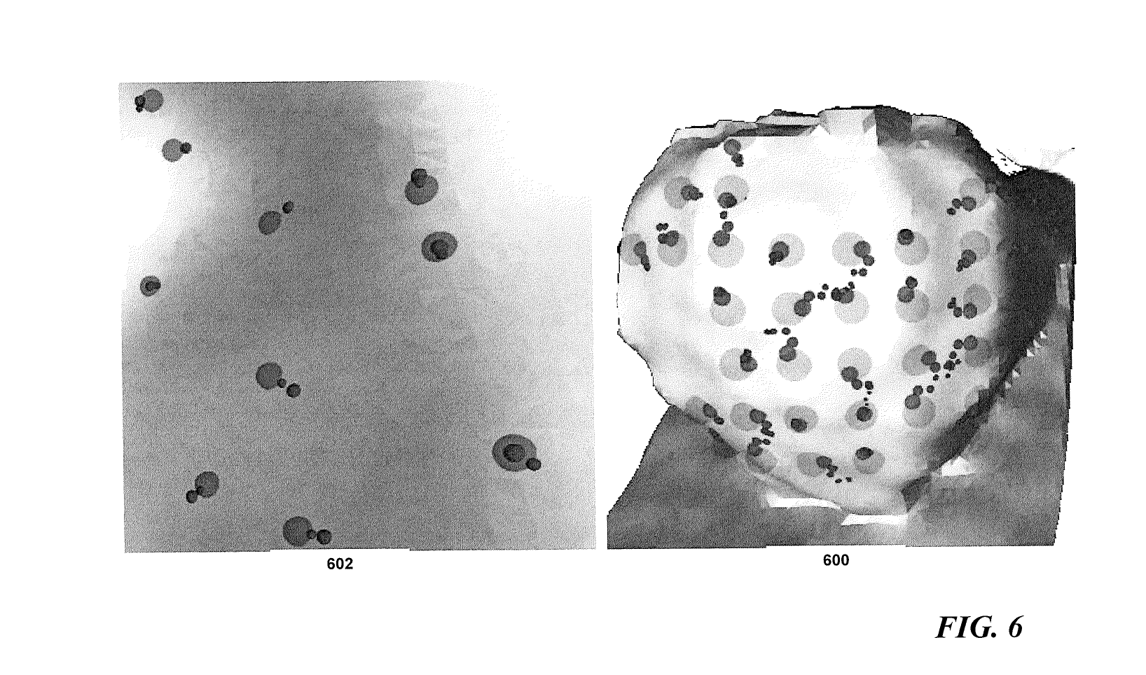

FIG. 6 is a schematic that shows exemplary key-points according to one example. 602 shows key-points localization using the coarse to fine approach described herein, applied to a high accuracy facial surface digitized in house using a Minolta vivid scanner. The 3D object 600 is an apple taken from the RGB-D Kinect dataset with key-points localized using the second approach described herein, after filtering and decimation to mitigate the noise in the 3D. The approach described herein is based on the down-hill simplex optimization method (starting from a coarse grid). The size of the spheres indicates the localization accuracy at the different iterations. Some of the neighboring initial grid points converge to the same final key-points. Missing initial grid points indicates that the approach did not converge in the specified number of iterations. Therefore, there are no final key-points found for them.

To illustrate the capabilities of the matching representation system, exemplary results are presented.

In a first example, 3D face recognition based on the method described herein for 3D static images is conducted on the Face Recognition Grand Challenge (FRGC) v2.0 as described in P. J. Phillips, P. J. Flynn, T. Scruggs, K. W. Bowyer, J. Chang, K. Hoffman, J. Marques, J. Min, and W. Worek, “Overview of the face recognition grand challenge,” IEEE computer society conference on Computer vision and pattern recognition, vol. 1, pp. 947-954, 2005, the 3D TEC twins as described in V. Vijayan, K. Bowyer, and P. Flynn, “3d twins and expression challenge,” IEEE international Conference on Computer Vision Workshops, IEEE, pp. 2100-2105, 2011 and the Bosphorus datasets as presented in A. Savran, N. Alyuz, H. Dibeklioglu, O. Celiktutan, B. Gokberk, B. Sankur, And L. Akarun, “Bosphorus database for 3d face analysis,” in Biometrics and Identity Management, Springer 2008, pp. 47-56 each incorporated herein by reference in its entirety. Face recognition can be considered as a subclass of object recognition, in which an instance face (individual) is identified, in one-to-many matching, or verified, in one-to-one matching. The deformations due to facial expression variations pose challenges to face recognition because they may obscure the distinctive facial geometries that enable recognition. Effective handling (such as expression modeling) or avoidance of the facial expression variations is essential for achieving high recognition rates.

In the first example, the successful class of approaches, that perform multiple sub-surface matching (which may be overlapping) in the semi-rigid regions of the face (the nose and the forehead), often using iterative closest point (ICP), is followed in order to evaluate the method described herein. Limiting the matching to the semi-rigid regions of the face (which are least affected by the facial expressions) and the use of the multiple matching strategy allow for better recognition chances. This is because for different facial expressions, some parts of the semi-rigid regions are even less affected than others, which may enable correct matching. The face matching approach described below reflects this strategy. The FRGC dataset comprises of 3D facial scans acquired using the Minolta vivid digitizer, organized into training and testing partitions. The facial scans are of a near frontal pose and many of them are under varying facial expressions. Utilizing all the 3D scans in the testing partition, 466 neutral facial scans were selected as the gallery (one scan per person). The remaining scans were split into a neutral (1944 scans) and a non-neutral expression probe (1597 scans) sets. These sets are used in the 3D face identification and verification tests in addition to the receiver operating characteristic (ROC) I, ROC II and ROC III curves described in the FRGC testing protocol. The 3D TEC dataset specifies the probes and the galleries of four experiments. The gallery size is 214 (107 twins). The 3D TEC scans are similar to those of the FRGC dataset in resolution and accuracy.

In the first and second examples using the 3D TEC dataset involve no facial expression variations among the twins (although the scans of experiment 1 are non-neutral) but experiment 3 and 4 match the twins under different facial expressions. For the tests on the Bosphorus dataset, a gallery is formed by picking the first neutral scan appearing in the dataset of each subject (105 subjects).

As described above, the key-points of the gallery range images, on and around the nose and the part of the forehead just above it, were detected. The local patches around them were then represented by their RAIK representations. Both of these two operations were performed during an offline stage. Similarly, the key-points and their local representations were computed for the probe range images, during an online stage. The kernels used for the detection of the key-points were 85-samples each but those used for the local surface representations were 150-sample each. On a 12-core machine and using an optimized c/c++ implementation of the method described herein, the computation of a 150-sample kernel takes on average about 45 μs and the computation of a single evaluation of the key-point function ƒₚ (u, v) as expressed in equation (25), including the computation of all its four kernels takes on average about 75 μs. Each local patch was represented by 7 integral kernels computed for the radii ranging from 3 mm to 15 mm with 2 mm steps, i.e., the representing image resolution is 150×7. On average, there are roughly from 90 to 140 key-points on the considered region of the face, depending on the value of the parameter α. For the extraction of a dissimilarity measure between a probe and a gallery range image, the local RAIK images of the probe, L_{1=1, . . . , m}_{ₚ}, are first matched against the gallery ones, L_{j=1, . . . , m}_{_{g}}, as expressed in equation (26) and equation (27). The least n dissimilarity measures among s″_{k=1, . . . , m}_{ₚ},denoted as s″_{i=1, . . . , n} are then aggregated into one dissimilarity measure as may be expressed in equation (28).

$$\begin{matrix}{s}_{ij}^{′} = {\sum }_{∀ ( u , v )} \vert {L}_{i} ( u , v ) - {L}_{j} ( u , v ) \vert & ( 26 ) \\ {s}_{k}^{″} = min \{ {s}_{ij}^{′} \vert i = k ⋀ j ∈ \{ 1 , … , {m}_{g} \} \} & ( 27 ) \\ s = {\sum }_{i = 1}^{n} {s}_{i}^{′′′} & ( 28 )\end{matrix}$$

After conducting a number of preliminary empirical tests, a value of 25 for n (roughly one fourth of the number of local patches) and 15 mm for the radius of the local neighborhood were deemed appropriate for 3D face recognition. Whereas the calculation of one s″ᵢⱼ as expressed in equation (26) is inexpensive, its computation mₚ×m_{g} times can be relatively expensive. However, heuristics can significantly reduce the number of needed computations. As seen in many key-point-based matching, the locations of the first few matches—s″ in this case—can be utilized to geometrically restrict the search scope for the other best matches. In the situation of matching a probe against a large number of gallery range images, the dimensionality of the RAIK images are reduced before the matching. Then, the top fraction of the best matches (those with the lowest s′ᵢⱼ) are then matched again but in full-dimension. In the next example, the dissimilarity as determined by equation (28) were used to populate the dissimilarity matrices. Next, the measures of each probe against all the galleries are normalized to range from zero to one as expressed in equation (31).

$$\begin{matrix}{s}_{min} ( p ) = min \{ s ( p , g ) \vert g ∈ \{ 1 , … , {m}_{g} \} \} & ( 29 ) \\ {s}_{max} ( p ) = max \{ s ( p , g ) \vert g ∈ \{ 1 , … , {m}_{g} \} \} & ( 30 ) \\ {s}_{n} ( p , g ) = \frac{s ( p , g ) - {s}_{min} ( p )}{{s}_{max} ( p ) - {s}_{min} ( p )} & ( 31 )\end{matrix}$$

Ten recognition tests were conducted on the aforementioned neutral and non-neutral sets of the FRGC dataset. The values of the adjustable parameters in both the key-point detection and the local surface representation were investigated in order to find the combination of those that gives an optimal face recognition performance. The parameters and their corresponding first rank identification rates are given in Table 1.

TABLE 1
Rank one identification rates for different values of α and β
parameters in the both key-points detection and the
local surface representation (FRGC dataset).

| | Parameters' values | | |
|---|---|---|---|
| No. | α/β | Neutral set rate | Non-neutral set rate |
| 1 | Both: +0.15/0.0 | 98.71% | 95.30% |
| 2 | Both: 0.0/0.0 | 98.46% | 95.93% |
| 3 | Both: 0.0/1.0 | 98.35% | 95.37% |
| 4 | Both: −0.15/0.0 | 98.97% | 95.93% |
| 5 | Both: −0.15/1.0 | 98.71% | 94.74% |
| 6 | Both: −0.2/0.0 | 98.87% | 95.74% |
| 7 | Both: −0.25/0.0 | 98.71% | 95.62% |
| 8 | Key-points: +0.15/0.0 | 98.87% | 96.49% |
| | Representation: −0.25/0.0 | | |
| 9 | Key-points: +0.15/0.0 | 98.87% | 96.24% |
| | Representation: −0.25/0.0 | | |
| 10 | No. 2 and 3 fused using | N/A | 96.39% |
| | the product rule | | |

From the results shown in the table 1, some recognition performance trends can be seen. First, when the adjustable parameters are set to neutral sensitivity and phase parameters, α=0.0 and β=1.0 (test no. 3), a recognition performance of 95.37% for the non-neutral face recognition and 98.35% for the neutral case is achieved. It is better than reported results in the prior art using ICP on the semi-rigid sub-regions of the face by noticeable margins (as shown in Table 4). Second, by disabling the phase information, β=0 (test no. 2), the identification rate improves particularly for the non-neutral case to an identification rate of 95.93% but only to 98.46% for the neutral case. It seems that the phase information may be sensitive to the deformations due to the facial expressions, it should be noted that neutral facial scans still have small expression deformations.

This is more apparent for the tests with higher sensitivity (negative a parameter). For example when α=−0.15, the identification rate drops to 94.74% for the non-neutral case but interestingly the identification rate for the neutral case increases to 98.71%. By disabling the phase information and increasing the kernel sensitivity, higher identification rates were achieved for both the neutral (98.97%) and the non-neutral (95.93%) cases. This increase in the rate of the neutral case actually corresponds to about 38% reduction in the identification errors when compared to that of test number 3 and 33% to that of test number 2. Tests number 5 and 6 indicate that further increases in kernel sensitivities, α<−0.15, results in gradual deterioration of the identification rates.

Another important finding (test number 8 and 9) is that when using a lower sensitivity, α=0.15, for the detection of the key-points but a higher one for their representations, α=−0.2 or α=−0.25, the identification rates for the non-neutral case further improve, respectively 96.49% (highest among them) and 96.24%. While these results are the best for the non-neutral scans, there is slight reduction in the identification rate for the neutral scans. The lower kernel sensitivity produces a lesser number of key-points (may explain the slight rate reduction for the neutral case) but also it can provide a better positioning of key-points under expression variations (may explain the increase in the rate for the non-neutral case). Alternatively, test number 10 shows that the score-level fusion can also improve the identification rates for the non-neutral case. Nonetheless, it remains sub-optimal to that of test number 8. The fusion of four tests (number 3, 4, 5 and 8) at the score level using the product rule produces even better results, a first rank identification rate of 99.13% for the neutral versus neutral case and 96.62% for the non-neutral case. These performance trends (mostly) holds for the performed tests on the 3D TEC dataset as shown in table 2 and the Bosphorus datasets as shown in table 3.

TABLE 2
Rank one identification rates of four selected values of α and β
parameters in both key-points detection and
local surface representation.

| Parameters' values | Exp1 | Exp2 | Exp3 | Exp4 |
|---|---|---|---|---|
| α/β | rate | rate | rate | rate |
| Both: 0.0/1.0 | 94.39% | 94.39% | 87.85% | 85.05% |
| Both: −0.15/0.0 | 94.86% | 95.33% | 86.91% | 88.79% |
| Both: −0.15/1.0 | 93.92% | 93.92% | 88.3% | 86.45% |
| Key-points: +0.15/0.0 | 95.33% | 94.39% | 83.64% | 85.98% |
| Representation: −0.2/0.0 | | | | |
| All combined | 95.79% | 97.2% | 87.38% | 85.98% |

TABLE 3
Rank one identification rates of four selected α and β parameters
in both key-points detection and local surface representation.

| Parameters' values | Neutral | Expressions | Occlusions | Combined |
|---|---|---|---|---|
| α/β | rate | rate | rate | rate |
| Both: 0.0/1.0 | 97.94% | 88.05% | 80.58% | 86.66% |
| Both: −0.15/0.0 | 97.94% | 88.43% | 82.41% | 87.92% |
| Both: −0.15/1.0 | 96.39% | 86.91% | 79.53% | 85.81% |
| Key-points: +0.15/0.0 | 97.94% | 90.8% | 81.1% | 88.33% |
| Representation: | | | | |
| −0.2/0.0 | | | | |
| All combined | 98.45% | 92.41% | 84.78% | 90.28% |

Table 4 shows a comparison of rank one identification rates of the method of the present disclosure with a first method as described by K. I. Chang, W. Bowyer, and P. J. Flynn, “Multiple nose region matching for 3d face recognition under varying facial expression,” IEEE Transactions on Pattern Analysis and Machine Intelligence, vol. 28, no. 10, pp. 1695-1700, 2006, a second method described in T. C. Faltemier, K. W. Bowyer, and P. J. Flynn, “A region ensemble for 3-d face recognition,” IEEE transactions on Information Forensics and security, vol. 3, no. 1, pp. 62-73, 2008 and a third method as described in A. S. Mian, M. Bennamoun, and R. Owens, “An efficient multimodal 2d-3d hybrid approach to automatic face recognition,” IEEE Transactions on Pattern Analysis and Machine Intelligence, vol. 29, no. 11, pp. 1927-1943, 2007.

TABLE 4
Comparisons of rank one identification rates of the method of the
present disclosure to the relevant prior art approaches
(multiple sub-surface matching using ICP).

| | | Neutral | Non-neutral | All |
|---|---|---|---|---|
| | | Versus | Versus | Versus |
| Approach | Gallery | Neutral | Neutral | Neutral |
| Method 1 | 449 | 96.6% | 80.6% | N/A |
| Method 2 | 466 | N/A | N/A | 97.2% |
| Method 3 | 466 | 98.82% | 93.74% | 96.2% |
| Method of the current | 466 | 99.1% | 96.49% | 97.78% |
| disclosure | | | | |

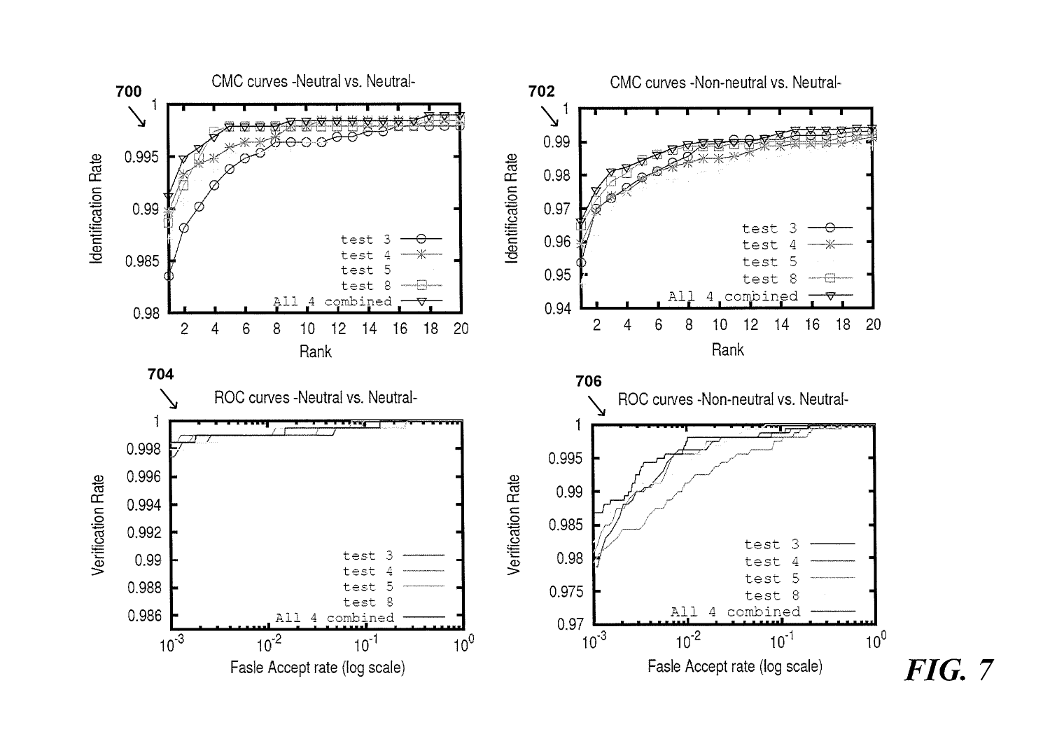

FIG. 7 is a schematic that shows graphs of the CMC and ROC according to one example. The cumulative matching characteristic (CMC) and the receiver operating characteristic (ROC) curves were computed for selected tests among those in Table 1. A first graph 700 shows the CMC curves for the neutral set for different parameters values shown in table 1. A second graph 702 shows the CMC curves for the non-neutral set for different parameters values shown in table 1. A third graph 704 shows the ROC curves for the neutral set for different parameters values given in table 1. A fourth graph 706 shows the ROC curves for the non-neutral set for different parameters values shown in table 1. The CMC curves also reveals that test number 8 (low sensitivity key-point detection and high sensitivity surface representation) outperforms other tests. For the neutral case, the first rank identification rate is slightly lower than that of test number 4, however, from rank 3 and on test number 8 is higher than test 4. For the non-neutral versus neutral case, test number 8 is consistently higher than the other ones but not than their combination (fusion).

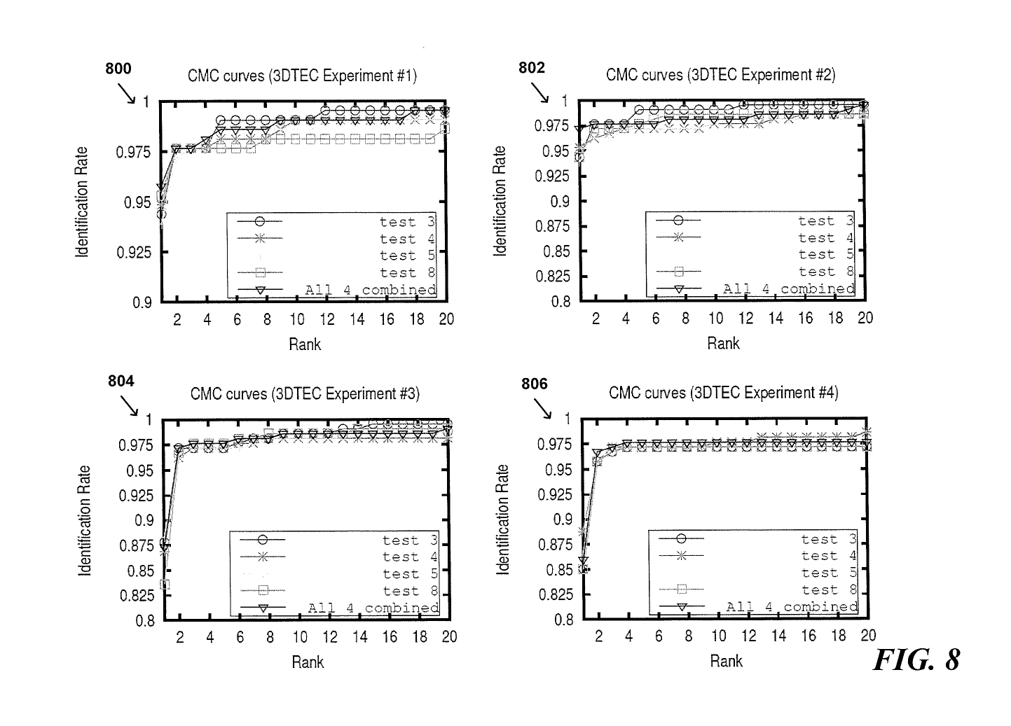

FIG. 8 is a schematic that shows exemplary CMC curves according to one example. FIG. 8 shows graphs of the CMC results for the four experiments for the tests given in Table 2 (3D TEC dataset). A first graph 800 shows the CMC curves for the first experiment for different parameters values listed in table 2. A second graph 802 shows the CMC curves for the second experiment for the parameters listed in table 2. A third graph 804 shows the CMC curves for the third experiment for the parameters listed in table 2. A fourth graph 806 shows the CMC curves for the fourth experiment for the parameters listed in table 2.

In the 3D TEC experiments 1 and 2 (in particular), there are noticeable small increases in the identification rates from the first rank to the second rank, FIG. 8. The cumulative rates then increase at a lower pace. This is in comparison to even higher increases from the first to the second rank rates for the 3D TEC experiments 3 and 4. This noticeable jump is caused by the inclusion of the other identical twin in the cumulative rate. From this, it can be concluded that the performance of the method described herein is capable of identifying identical twins with no noticeable performance degradation (discriminative). When the twins are under different facial expressions, the method described herein also highly performs but there is a small recognition performance degradation.

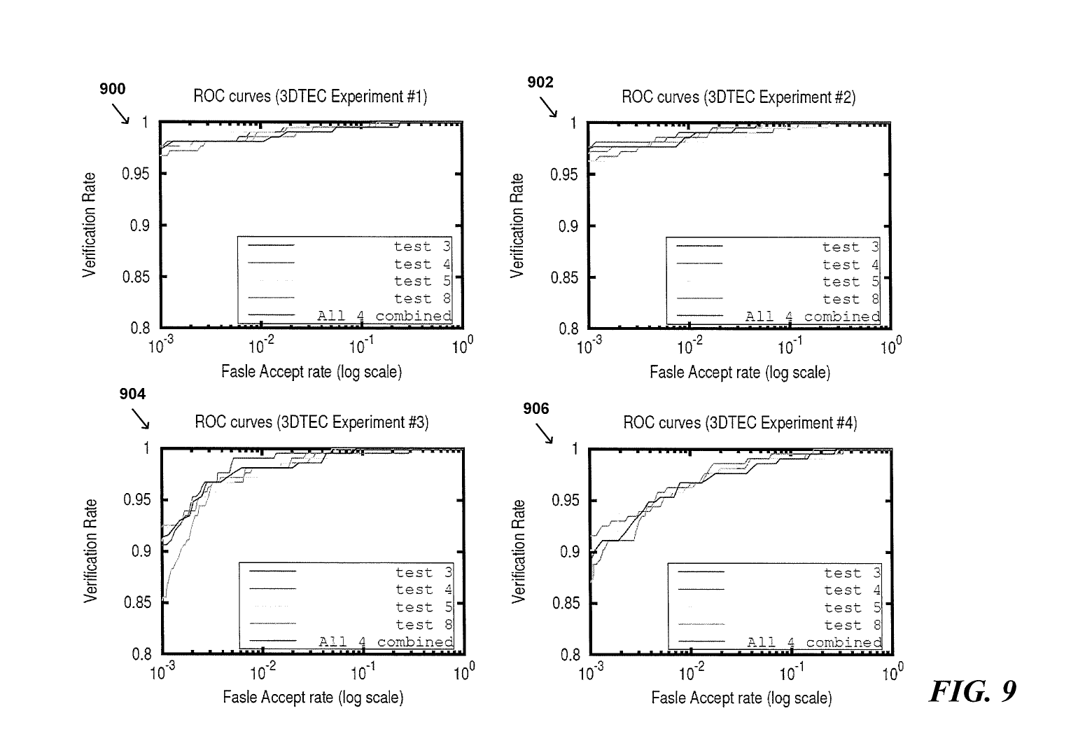

FIG. 9 is a schematic that shows exemplary ROC curves according to one example. FIG. 9 shows the ROC curves for the tests given in Table 2 (3D TEC dataset). A first graph 900 shows the ROC curves for the first experiment for different parameters values listed in table 2. A second graph 902 shows the ROC curves for the second experiment for the parameters listed in table 2. A third graph 904 shows the ROC curves for the third experiment for the parameters listed in table 2. A fourth graph 906 shows the ROC curves for the fourth experiment for the parameters listed in table 2.

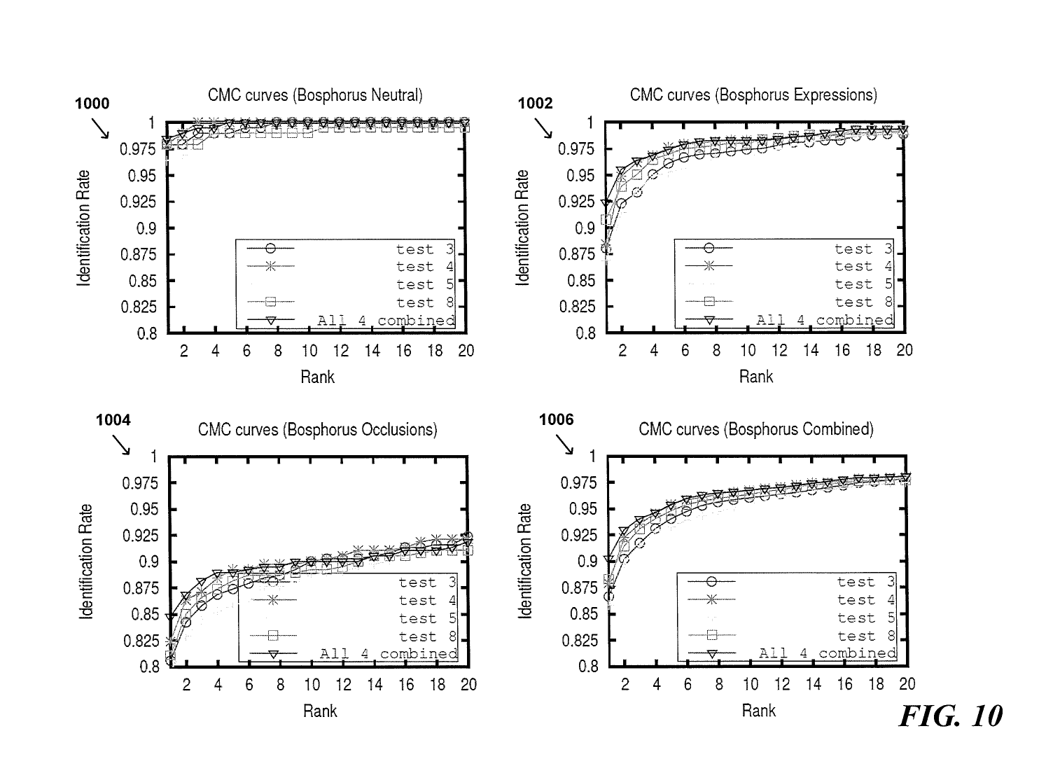

FIG. 10 is a schematic that shows exemplary CMC curves according to one example. FIG. 10 shows the CMC curves for the tests given in table 3 (Bosphorus dataset). A first graph 1000 shows the CMC curves for Bosphorus Neutral dataset for different parameters values listed in table 3. A second graph 1002 shows the CMC curves for the Bosphorus expressions dataset for the parameters listed in table 3. A third graph 1004 shows the CMC curves for the Bosphorus occlusions dataset for the parameters listed in table 3. A fourth graph 1006 shows the CMC curves for the Bosphorus combined dataset for the parameters listed in table 3. The CMC curves of the Bosphorus dataset indicates very high recognition performance for the neutral scans as some of the curves start from high first rank rates and reaches a 100% rate around the third rank. Although the approach can achieve good results for the scans under occlusions, it can be seen that occlusions are more challenging than facial expressions.

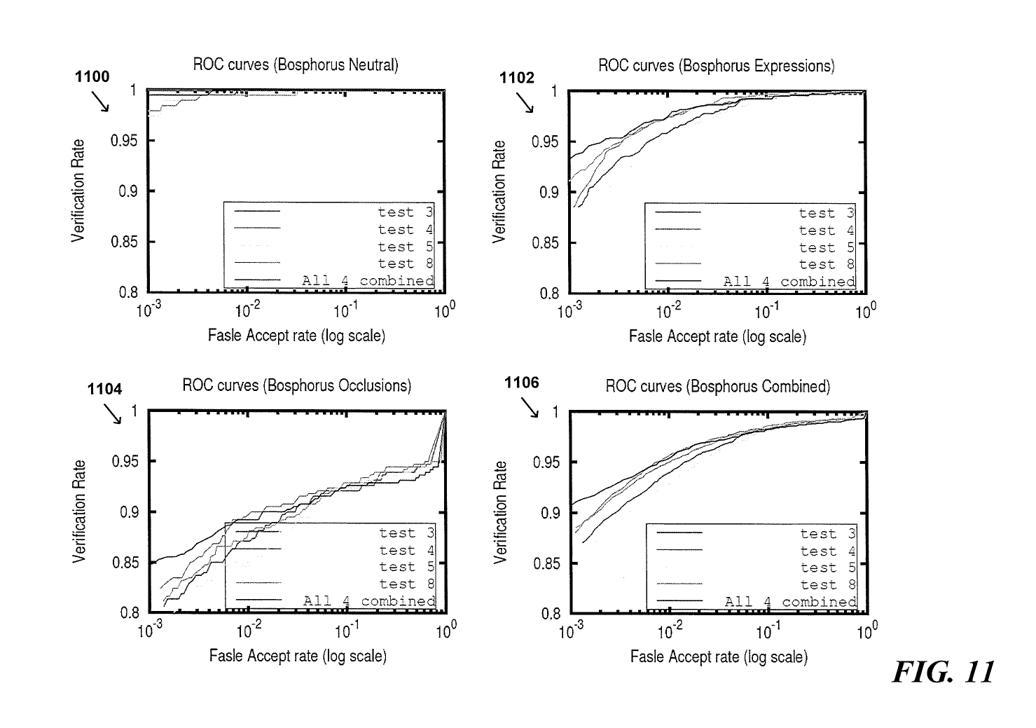

FIG. 11 is a schematic that shows exemplary ROC curves according to one example. FIG. 11 shows the ROC curves for the tests given in Table 3 (Bosphorus dataset). A first graph 1100 shows the ROC curves for Bosphorus Neutral dataset for different parameters values listed in table 3. A second graph 1102 shows the ROC curves for the Bosphorus expressions dataset for the parameters listed in table 3. A third graph 1104 shows the ROC curves for the Bosphorus occlusions dataset for the parameters listed in table 3. A fourth graph 1106 shows the ROC curves for the Bosphorus combined dataset for the parameters listed in table 3.

The verification rates in all of the four tests on all the different datasets as shown in FIGS. 7, 9, and 11 are particularly high for the neutral case with close margins. In case of the FRGC dataset, for example, it is around 99.8% at 0.001 false accept rate (FAR) with the highest rate for tests number 4 and 5 (99.85% at 0.001 FAR) and 99.85% at 0.001 FAR for them combined. However, there is a considerable variations among the verification rates in the non-neutral versus neutral case, in which the highest was achieved by test number 8, 98.25% at 0.001 FAR compared to 97.87% at 0.001 FAR by test number 3. Their fusion achieves 98.69% at 0.001 FAR.

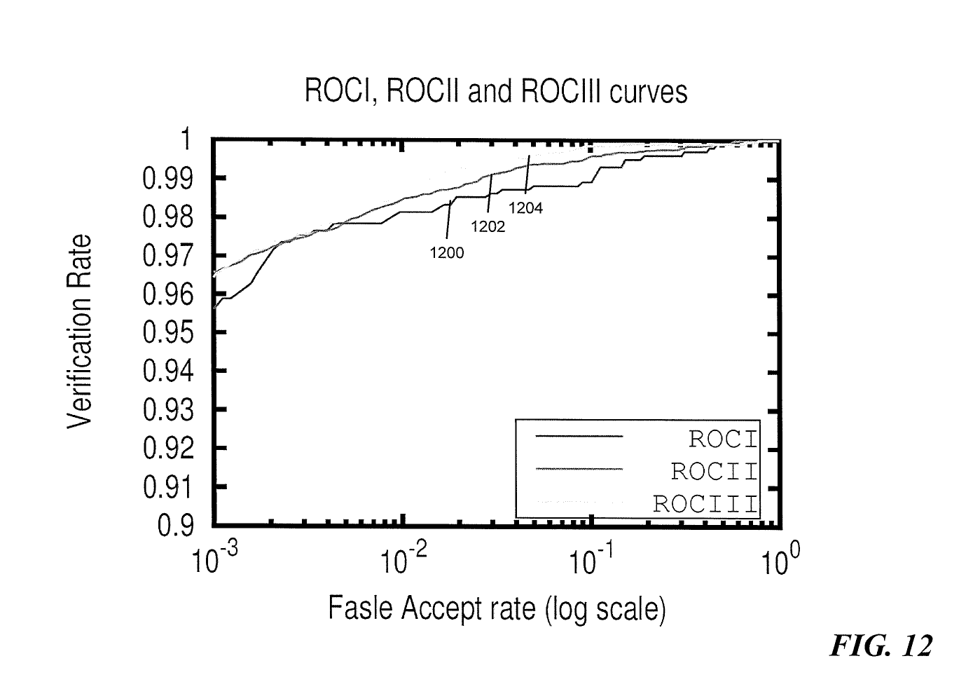

FIG. 12 is a schematic that shows exemplary FRGC ROCI, ROCII, and ROC III curves according to one example. The FRGC ROC I 1200, ROC II 1202, and ROC III 1204 curves for test number 4 in Table 1. In the exemplary results presented, the method described herein does not utilize any learning algorithms on top of the descriptors/features to maximize performance (as many other approaches does) but rather it relies directly on the qualities of the RAIK descriptors. In one embodiment, the method described herein may additionally use learning algorithms to further maximize the performance.

In a second example, the RAIK features along with the down-hill based approach to key-points localization as described herein are applied to perform 3D object classification. A key challenge in object class recognition is the high variability in the shapes of the objects within the same class. The ability of an object classification system to classify objects under this variability and generalize to unseen objects is critical to its performance.

The RGB-D object dataset as presented in K. Lai, L. Bo, X. Ren, and D. Fox, “A large-scale hierarchical multi-view rgb-d object dataset,” IEEE International conference on Robotics and Automation (ICRA), IEEE, pp. 1817-1824, 2011, which is acquired using Microsoft Kinect 3D scanner, is used in the second example. The dataset comprises of 300 household objects in 51 classes. Of each object, there are few video sequences for training and other few ones for evaluation. The video sequences are synchronized and geo-registered texture and 3D shape (range) images at a resolution of 640×480 and a frame rate of 30 frames per second. In the conducted experiments, only the 3D shape modality is utilized. Without the texture cues, some of the classes in the dataset may be better grouped under one class.

For example, there are no objective criteria against which any 3D classifier can differentiate between the different box-shaped object classes of comparable sizes such as the “cereal box” and “food box” classes. Because of this some classes were merged to form one object class. The merged classes include the box-shaped object classes (into one object class) and the different bottle classes (also into one object class). After the merging of several object classes the total number of the different object classes became 28. The comparisons against the other approaches were performed on the same 28 classes and the test queries.

The object recognition system has two phases. The first is an offline training and the second is an online object classification. Since the 3D images involve a significant level of noise, they are further filtered and spatially decimated (every other horizontal and vertical pixel are taken and additionally the pixel values are divided by 2), called level zero. An additional level of decimation is also calculated, called level one. The two level pyramid mitigate the high noise in the range data. Level zero range images have more details but are affected by more noise in comparison to level one range images. The RAIK key-points and features were computed for the two decimation levels. At each level, two sizes of the local features were considered around each key-point. This is to provide the approach with the ability to cater for the size variations among the objects (the objects are physically of different sizes). The first size of the local features has 7 RAIKs, ranging from 3-pixel to 15-pixel radius with 2-pixel steps, but the second has only the most inner 3 RAIKs of them. That means the RAIKs range from a radius of 14 mm for the smaller feature at level zero (2 mm per pixel) to 60 mm for the large feature at level one (4 mm per pixel). During the training, only every 5th frame is considered (temporal subsampling) but for the classification every 10th frame of the dataset videos is considered. In the second example, the kernels used for the detection of the key-points are 49-sample each. The calculation of a single evaluation of the key-point function ƒₚ (u, v) as expressed in equation (25), including the determining of all its two kernels takes on average about 27 μs. The training phase proceeds as follows. First, the key-points in the considered 3D frames are localized and the local descriptors are calculated. The dimensionality of the local descriptors is then reduced. Let the object class be c and the descriptor size be s and the image level be l. Let their descriptors be grouped in one set, denoted as X_{c,s,l}. This resulted in 28×2×2 descriptor sets. From each set, X_{c,s,l}, a kD-tree is constructed to speed up the nearest neighbor search during the classification phase.

During the online classification phase, smaller sets of the local descriptors are extracted from the considered frames of the query video sequence. The descriptors of the frame f at the descriptor size s and at the image level l form a set Y_{f,s,l}. From each Y_{f,s,l} set, a dissimilarity measure to each corresponding X_{c,s,l} set is computed (the same descriptor size and image level). Then, the scores are aggregated in an overall dissimilarity score, as expressed in equation (32) where d(., .) is the Euclidean distance. The class c which has the lowest dissimilarity, s(c), is deemed as the object class of the video sequence. However, the dissimilarity measures are not calculated for every object class. The measures are calculated only for potential object class candidates (a fraction of total number of object classes) which are identified based on a coarse voting scheme. In this voting scheme, there are four tuple sets of descriptors and object class labels (one for each descriptor size and image level combination). The tuple sets are for all the object classes combined, χ′_{s,l}={(x,c)|xε∪_{∀c} χ_{c,s,l}}. The voting is carried out by finding the k-nearest neighbors (a number of 10 is used) of every descriptor y of the query sequence. Their corresponding labels are then used in the vote for the different object classes. The classes are ranked based on their received votes and the dissimilarity measures are only computed for the top five classes.

$$s ( c ) = {\sum }_{∀ f , s , l} {\sum }_{y ∈ {Y}_{f , s , l}} {min}_{x ∈ {χ}_{c , s , l}} d ( x , y ) \qquad ( 32 )$$

The object classification performance was measured for four different values of α and β parameters, shown in Table 5, and for the two cases when the object class instances (objects) in the testing and the training video datasets are mutually inclusive and when they are mutually exclusive. Generally, the parameter α has a more significant influence on the classification rates than that of the parameter β. However, it has been noticed that the choice of a non-zero β parameter value enhances the classification rates for particular classes but has an adverse effects on some other classes. The tests indicate that at an a parameter of −0.15 (the highest sensitivity among the four tests) which was optimal in the face recognition example, is improved by reducing the RAIK sensitivity (i.e., larger a values). This is equally observed in both the mutually inclusive and exclusive cases. The reason for considerable discrepancies between the optimal parameters in the second example and the face recognition example is because of the change in the 3D surface digitization quality and/or the difference in the nature of the problem. The ability of the RAIK descriptors to generalize to unseen object instances is evident from the non-significant decline in performance from the mutually inclusive case to the exclusive case. The classification performance of the method of the present disclosure is compared against that of the Scale Invariant Feature Transform (SIFT) approach described in D. G. Lowe, “Distinctive image features from scale-invariant key-points,” International journal of computer vision, vol. 60, no. 2, pp. 91-110, 2004. The detection of the SIFT key-points on the 3D surfaces has produced very sparse key-points that was not sufficient to conduct object classification. Note that some approaches use only the SIFT descriptors at every pixel or 3D point of the 3D surface as for example described in K. Lai, L. Bo, X. Ren, and D. Fox, “A large-scale hierarchical multi-view rgb-d object dataset,” IEEE International Conference on Robotics and Automation (ICRA), pp. 1817-1824, 2011. However, this requires an accurate segmentation of the object of interest from the background (which is hardly achieved for the non-manual segmentation) and prevents such approaches from the other advantages of the key-points detection/description paradigm, e.g., robustness to occlusions. The Harris corner detector described in C. Harris and M. Stephens, “A combined corner and edge detector.” in Alvey vision conference, vol. 15, Manchester, U K, 1988, p. 50 is used instead to localize to the key-points on the 3D surface which produced much denser key-points.

Then, the SIFT descriptor is used to describe the regions around the detected key-points. For the matching, the exact technique utilized by the method of the present disclosure was used except that the SIFT descriptors were not compressed. For the mutually inclusive testing and training datasets, the SIFT has achieved a classification rate of (47.76%) compared to 64.66% for the method of the present disclosure. While for the mutually exclusive testing and training datasets, the SIFT rate was (44.53%) in comparison to 59.48% for the method of the present disclosure.

In one embodiment, the method described herein further includes detecting key-points of static images and 3D videos. The key-points are determined by finding the local minima and maxima location of a scalar function. The scalar function is based on at least two profile trebles. Table 5 shows the object classification rate for different values of α and β parameters in both the key-points detection and the local surface representation. The rates are for the 3D modality only and based on the key-points detection/description paradigm. The classification rates are provided for the two cases: (1) when the same instances of the object classes are allowed to be in both the test and the training datasets (2) when all the video sequences of the same query object class instance are excluded from the training dataset.

TABLE 5
The object classification rates for different values of α and β
parameters in both the key-points detection and
the local surface representation.

| | Parameters' values | Classification rate | Classification rate |
|---|---|---|---|
| No. | α/β | Case 1 | Case 2 |
| 1 | Both: −0.15/1.0 | 59.48% | 55.89% |
| 2 | Both: 0.6/1.0 | 63.36% | 58.05% |
| 3 | Key-points: +2.0/1.0 | 64.37% | 59.48% |
| | Representation: +0.2/1.0 | | |
| 4 | Key-points: +2.0/0.0 | 64.66% | 59.34% |
| | Representation: +0.2/0.0 | | |

The method describes herein may be used in object classification, object recognition, 3D face recognition, visual emotion recognition, visual human computer interaction, surveillance, human activity recognition, 3D gesture recognition, 3D vision for robotics, 3D modeling and mesh completion, and 3D scene stitching.

The method described herein has several advantages including completeness and high descriptiveness, rotation invariance, adjustability to varying 3D surface noise accurate extraction and sampling of the descriptors, sub-pixel localization accuracy of the key points.

Next, a hardware description of the computer according to exemplary embodiments is described with reference to FIG. 13. In FIG. 13, the computer includes the CPU 1300 which performs the processes described above/below. The process data and instructions may be stored in memory 1302. These processes and instructions may also be stored on a storage medium disk 1304 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computer communicates, such as a server or computer.

Further, the claimed advancements may be provided as a utility application, background daemon, or component of an operating system, or combination thereof, executing in conjunction with CPU 1300 and an operating system such as Microsoft Windows 7, UNIX, Solaris, LINUX, Apple MAC-OS and other systems known to those skilled in the art.

In order to achieve the computer 100, the hardware elements may be realized by various circuitry elements, known to those skilled in the art. For example, CPU 1300 may be a Xenon or Core processor from Intel of America or an Opteron processor from AMD of America, or may be other processor types that would be recognized by one of ordinary skill in the art. Alternatively, the CPU 1300 may be implemented on an FPGA, ASIC, PLD or using discrete logic circuits, as one of ordinary skill in the art would recognize. Further, the CPU 1300 may be implemented as multiple processors cooperatively working in parallel to perform the instructions of the inventive processes described above.

The computer 100 in FIG. 13 also includes a network controller 1306, such as an Intel Ethernet PRO network interface card from Intel Corporation of America, for interfacing with network 102. As can be appreciated, the network 102 can be a public network, such as the Internet, or a private network such as an LAN or WAN network, or any combination thereof and can also include PSTN or ISDN sub-networks. The network 102 can also be wired, such as an Ethernet network, or can be wireless such as a cellular network including EDGE, 3G and 4G wireless cellular systems. The wireless network can also be WiFi, Bluetooth, or any other wireless form of communication that is known.

The computer 100 further includes a display controller 1308, such as a NVIDIA GeForce GTX or Quadro graphics adaptor from NVIDIA Corporation of America for interfacing with display 1310, such as a Hewlett Packard HPL2445w LCD monitor. A general purpose I/O interface 1312 interfaces with a keyboard and/or mouse 1314 as well as a touch screen panel 1316 on or separate from display 1310. General purpose I/O interface also connects to a variety of peripherals 1318 including printers and scanners, such as an OfficeJet or DeskJet from Hewlett Packard.

A sound controller 1320 is also provided in the computer 100, such as Sound Blaster X-Fi Titanium from Creative, to interface with speakers/microphone 1322 thereby providing sounds and/or music.

The general purpose storage controller 1324 connects the storage medium disk 304 with communication bus 1326, which may be an ISA, EISA, VESA, PCI, or similar, for interconnecting all of the components of the computer 100. A description of the general features and functionality of the display 1310, keyboard and/or mouse 1314, as well as the display controller 1308, storage controller 1324, network controller 1306, sound controller 1320, and general purpose I/O interface 1312 is omitted herein for brevity as these features are known.

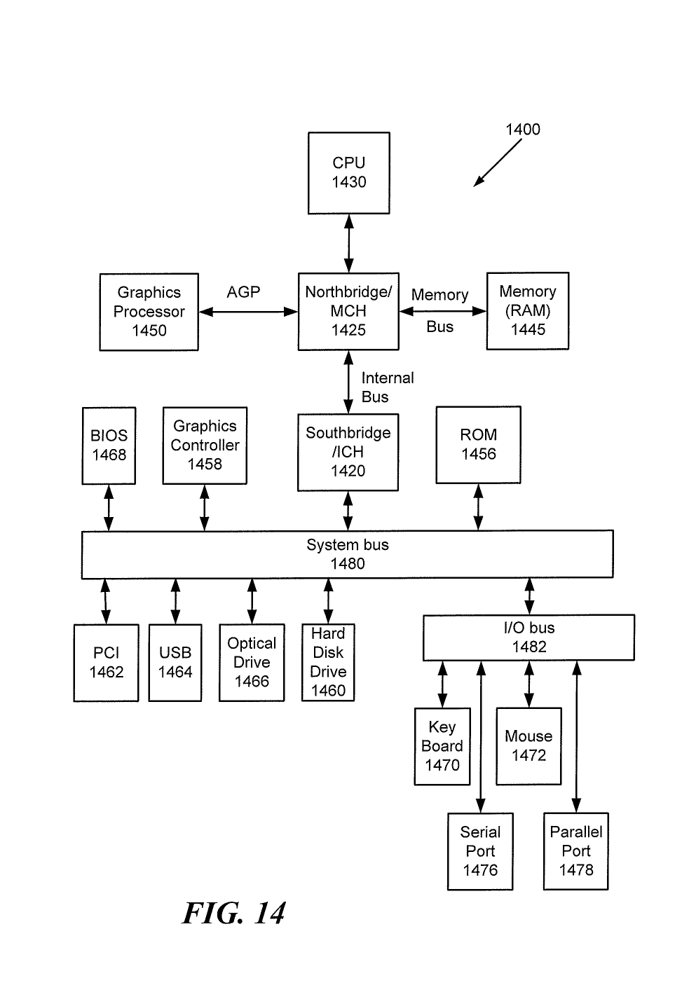

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in the circuitry on a single chipset, as shown on FIG. 14.

FIG. 14 shows a schematic diagram of a data processing system, according to certain embodiments, for detecting key points. The data processing system is an example of a computer in which specific code or instructions implementing the processes of the illustrative embodiments may be located to create a particular machine for implementing the above-noted process.

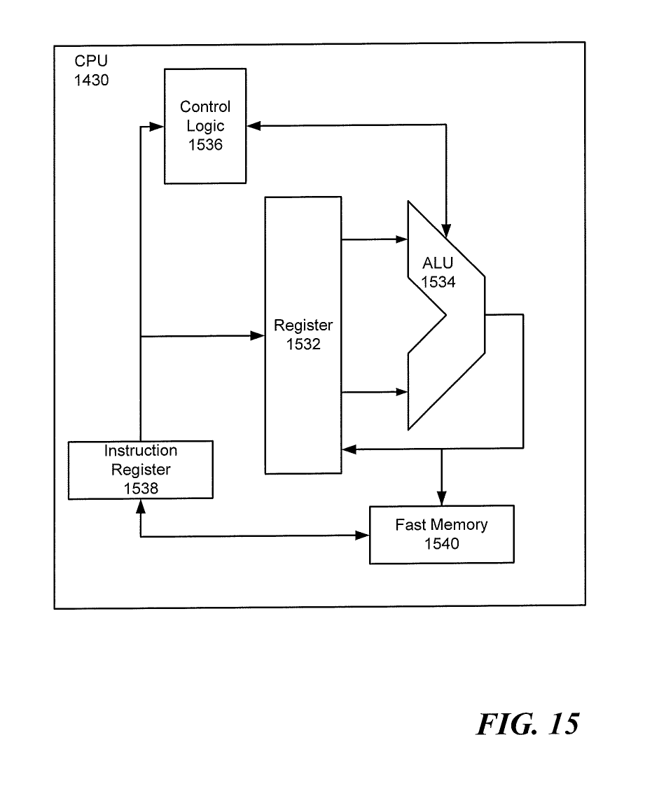

In FIG. 14, data processing system 1400 employs a hub architecture including a north bridge and memory controller hub (NB/MCH) 1425 and a south bridge and input/output (I/O) controller hub (SB/ICH) 1420. The central processing unit (CPU) 1430 is connected to NB/MCH 1425. The NB/MCH 1425 also connects to the memory 1445 via a memory bus, and connects to the graphics processor 1450 via an accelerated graphics port (AGP). The NB/MCH 1425 also connects to the SB/ICH 1420 via an internal bus (e.g., a unified media interface or a direct media interface). The CPU Processing unit 1430 may contain one or more processors and may even be implemented using one or more heterogeneous processor systems. For example, FIG. 15 shows one implementation of CPU 1430.

Further, in the data processing system 1400 of FIG. 14, SB/ICH 1420 is coupled through a system bus 1480 to an I/O Bus 1482, a read only memory (ROM) 1456, an universal serial bus (USB) port 1464, a flash binary input/output system (BIOS) 1468, and a graphics controller 1458. In one implementation, the I/O bus 1482 can include a super I/O (SIO) device.

PCI/PCIe devices can also be coupled to SB/ICH 1420 through a PCI bus 1462. The PCI devices may include, for example, Ethernet adapters, add-in cards, and PC cards for notebook computers. Further, the hard disk drive (HDD) 1460 and optical drive 1466 can also be coupled to the SB/ICH 1420 through the system bus 1480. The Hard disk drive 1460 and the optical drive or CD-ROM 1466 can use, for example, an integrated drive electronics (IDE) or serial advanced technology attachment (SATA) interface.

In one implementation, a keyboard 1470, a mouse 1472, a parallel port 1478, and a serial port 1476 can be connected to the system bus 1480 through the I/O bus 1482. Other peripherals and devices that can be connected to the SB/ICH 1420 include a mass storage controller such as SATA or PATA (Parallel advanced technology attachment), an Ethernet port, an ISA bus, a LPC bridge, SMBus, a DMA controller, and an Audio Codec (not shown).

In one implementation of the CPU 1430, the instruction register 1538 retrieves instructions from the fast memory 1540. At least part of these instructions are fetched from the instruction register 1538 by the control logic 1536 and interpreted according to the instruction set architecture of the CPU 1430. Part of the instructions can also be directed to the register 1532. In one implementation, the instructions are decoded according to a hardwired method, and in another implementation, the instructions are decoded according a microprogram that translates instructions into sets of CPU configuration signals that are applied sequentially over multiple clock pulses. After fetching and decoding the instructions, the instructions are executed using the arithmetic logic unit (ALU) 1534 that loads values from the register 1532 and performs logical and mathematical operations on the loaded values according to the instructions. The results from these operations can be feedback into the register and/or stored in the fast memory 1540. According to certain implementations, the instruction set architecture of the CPU 1430 can use a reduced instruction set architecture, a complex instruction set architecture, a vector processor architecture, a very large instruction word architecture. Furthermore, the CPU 1430 can be based on the Von Neuman model or the Harvard model. The CPU 1430 can be a digital signal processor, an FPGA, an ASIC, a PLA, a PLD, or a CPLD. Further, the CPU 1430 can be an x86 processor by Intel or by AMD; an ARM processor, a Power architecture processor by, e.g., IBM; a SPARC architecture processor by Sun Microsystems or by Oracle; or other known CPU architecture.

The present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The functions and features described herein may also be executed by various distributed components of a system. For example, one or more processors may execute these system functions, wherein the processors are distributed across multiple components communicating in a network. The above-described hardware description is a non-limiting example of corresponding structure for performing the functionality described herein.

The hardware description above, exemplified by any one of the structure examples shown in FIG. 13 or 14, constitutes or includes specialized corresponding structure that is programmed or configured to perform the algorithm shown in FIG. 5.

A system that includes the features in the foregoing description provides numerous advantages to users. In particular, the system and associated methodology of the present disclosure provides a 3D surface matching representation, which is discriminative, rotation invariant, complete, scalable, with adjustable sensitivity to the underling surface and comparatively efficient. The methodology described herein may be used for 3D computer vision applications. In addition, the methodology described herein may be used for object classification. The method has the advantage of being scalable. The present disclosure provides an improvement to the technical field by determining the 3D surface matching representation and key-points with high accuracy while minimizing the computational requirements. The method describe herein has also the advantage of having an adjustable sensitivity to enhance the accuracy.

Obviously, numerous modifications and variations are possible in light of the above teachings. It is therefore to be understood that within the scope of the appended claims, the invention may be practiced otherwise than as specifically described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A method for three-dimensional (3D) local surface matching, the method comprising:
extracting a treble of 3D profiles from data corresponding to a 3D local surface, wherein the treble of the 3D profiles includes a central profile and two adjacent profiles;
calculating a scalar sequence pair based on the treble of the 3D profiles;
calculating, using processing circuitry, adjustable integral kernels based on the scalar sequence pair; and
providing the adjustable integral kernels to pattern recognition applications.

2. The method of claim 1, wherein the extracting of the central profile comprises:
intersecting a first sphere with fitted bicubic functions to the 3D local surface; and
sampling the central profile at an equally spaced distance using a second sphere with a smaller radius than the first sphere, wherein the center of the second sphere is located on the central profile.

3. The method of claim 2, wherein the fitted bicubic functions are determined by fitting bicubic functions to range pixel patches having a predetermined size.

4. The method of claim 2, wherein the radius of the second sphere is determined iteratively by computing a geodesic distance of the central profile and estimating a radius that gives a predetermined number of samples.

5. The method of claim 4, wherein the geodesic distance is a function of at least an Euclidean distance between samples at each iteration.

6. The method of claim 1, wherein the extracting of the two adjacent profiles comprises:
determining planes perpendicular to the central profile at each sample point of the central profile; and
intersecting the planes with spheres and the 3D local surface.

7. The method of claim 1, further comprising:
repeating the extracting and calculating steps to extract at least a second set of adjustable integral kernels based on at least a second treble; and
determining, using the processing circuitry, key-points as local minima and maxima locations of a scalar function, wherein the scalar function is based on the adjustable integral kernels and at least the second set of adjustable integral kernels.

8. The method of claim 7, wherein the scalar function is expressed as
$${f}_{p} ( u , v ) = \frac{1}{det ( D + γ I )}$$
where D is given by D=M^{T}M, M=(k₁−k̅) . . . (kₖ−k̅), k are the integral kernels, γ is a predetermined parameter, u, v are mapping variables and I is an identity matrix.

9. A system for three-dimensional (3D) local surface matching, the system comprising:
processing circuitry configured to
extract a treble of 3D profiles from data corresponding to a 3D local surface, wherein the treble of the 3D profiles includes a central profile and two adjacent profiles,
calculate a scalar sequence pair based on the treble of the 3D profiles,
calculate adjustable integral kernels based on the scalar sequence pair, and
provide the adjustable integral kernels to pattern recognition applications.

10. The system of claim 9, wherein the extracting of the central profile comprises:
intersecting a first sphere with fitted bicubic functions to the 3D local surface; and
sampling the central profile at an equally spaced distance using a second sphere with a smaller radius than the first sphere, wherein the center of the second sphere is located on the central profile.

11. The system of claim 10, wherein the fitted bicubic functions are determined by fitting bicubic functions to range pixel patches having a predetermined size.

12. The system of claim 10, wherein the radius of the second sphere is determined iteratively by computing a geodesic distance of the central profile and estimating a radius that gives a predetermined number of samples.

13. The system of claim 12, wherein the geodesic distance is a function of at least an Euclidean distance between samples at each iteration.

14. The system of claim 9, wherein the extracting of the two adjacent profiles comprises:
determining planes perpendicular to the central profile at each sample point of the central profile; and
intersecting the planes with spheres and the 3D local surface.

15. The system of claim 9, wherein the processing circuitry is further configured to:
repeat the extracting and calculating steps to extract at least a second set of adjustable integral kernels based on at least a second treble; and
determine key-points as local minima and maxima locations of a scalar function, wherein the scalar function is based on the adjustable integral kernels and at least the second set of adjustable integral kernels.

16. The system of claim 15, wherein the scalar function is expressed as
$${f}_{p} ( u , v ) = \frac{1}{det ( D + γ I )}$$
where D is given by D=M^{T}M, M=[(k₁−k̅) . . . (kₖ−k̅)], k are the integral kernels, γ is a predetermined parameter, u, v are mapping variables and I is an identity matrix.

17. A non-transitory computer readable medium storing computer-readable instructions therein which when executed by a computer causes the computer to perform a method for three-dimensional (3D) local surface matching, the method comprising:
extracting a treble of 3D profiles from data corresponding to a 3D local surface, wherein the treble of the 3D profiles includes a central profile and two adjacent profiles;
calculating a scalar sequence pair based on the treble of the 3D profiles;
calculating, using processing circuitry, adjustable integral kernels based on the scalar sequence pair; and
providing the adjustable integral kernels to pattern recognition applications.

18. The non-transitory computer readable medium of claim 17, wherein the method further comprises:
repeating the extracting and calculating steps to extract at least a second set of adjustable integral kernels based on at least a second treble; and
determining, using the processing circuitry, key-points as local minima and maxima locations of a scalar function, wherein the scalar function is based on the adjustable integral kernels and at least the second set of adjustable integral kernels.

19. The non-transitory computer readable medium of claim 17, wherein the extracting of the central profile comprises:
intersecting a first sphere with fitted bicubic functions to the 3D local surface; and
sampling the central profile at an equally spaced distance using a second sphere with a smaller radius than the first sphere, wherein the center of the second sphere is located on the central profile.

20. The non-transitory computer readable medium of claim 17, wherein the extracting of the two adjacent profiles comprises:
determining planes perpendicular to the central profile at each sample point of the central profile; and
intersecting the planes with spheres and the 3D local surface.
